(19) United States
(12) Patent Application Publication
(10) Pub. No.: US 2025/0301507 A1
(43) Pub. Date: Sep. 25, 2025

(54) METHOD AND APPARATUS FOR TRANSMITTING UPLINK SIGNAL BY TERMINAL IN WIRELESS COMMUNICATION SYSTEM

(71) Applicant: Samsung Electronics Co., Ltd., Gyeonggi-do (KR)

(72) Inventors: Sungjin PARK, Gyeonggi-do (KR); Hyoungju JI, Gyeonggi-do (KR); Kyungjun CHOI, Gyeonggi-do (KR)

(21) Appl. No.: 19/086,742

(22) Filed: Mar. 21, 2025

(30) Foreign Application Priority Data
Mar. 21, 2024 (KR) 10-2024-0039074

(51) Int. Cl. H04W 74/0833; H04W 72/21

(52) U.S. Cl. CPC H04W 74/0833; H04W 72/21

(57) ABSTRACT

The disclosure relates to a 5G or 6G communication system for supporting a higher data transmission rate. A method performed by a terminal in a wireless communication system includes transmitting, to a base station, a random access preamble on a physical random access channel (PRACH), and receiving, from the base station, in response to the transmitted random access preamble, a random access response (RAR) message including an RAR uplink (UL) grant, wherein, in case that a physical UL shared channel (PUSCH) scheduled by the RAR UL grant overlaps with a physical UL control channel (PUCCH) carrying UL control information (UCI), the UCI is not multiplexed on the PUSCH.

### CROSS-REFERENCE TO RELATED APPLICATION(S)

This application is based on and claims priority under 35 U.S.C. § 119 to Korean Patent Application No. 10-2024-0039074, filed on Mar. 21, 2024, in the Korean Intellectual Property Office, the disclosure of which is incorporated herein by reference in its entirety.

### BACKGROUND

### 1. Field

The disclosure relates generally to operations of a terminal and a base station in a wireless communication system, and more particularly, to uplink (UL) signal transmission of a terminal in the wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

A long term evolution (LTE) system employs an orthogonal frequency division multiplexing (OFDM) scheme in a downlink (DL) and employs a single carrier frequency division multiple access (SC-FDMA) scheme in a UL. The UL refers to a radio link via which a UE or a mobile station (MS) transmits data or control signals to a base station (BS) or eNode B, and the DL refers to a radio link via which the base station transmits data or control signals to the UE. The above access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

The eMBB aims at providing a data rate higher than that supported by existing LTE, LTE-A, or LTE-Pro. For example, in the 5G communication system, eMBB must provide a peak data rate of 20 gigabits per second (Gbps) in the DL and a peak data rate of 10 Gbps in the UL for a single base station. Furthermore, the 5G communication system must provide an increased user-perceived data rate to the UE, as well as the maximum data rate. To satisfy such requirements, transmission/reception technologies including a further enhanced MIMO transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of many UEs in a cell, enhancement coverage of UEs, improved battery time, a reduction in the cost of a UE, and the like, to effectively provide the IoT. Since the Internet of Things provides communication functions while being provided to various sensors and various devices, it must support many UEs (e.g., 1,000,000 UEs/km²) in a cell. The UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive and may require a very long battery life-time such as 10 to 15 years because it is difficult to frequently replace the battery of the UE.

The URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band to secure reliability of a communication link.

The three services in 5G, that is, eMBB, URLLC, and mMTC, may be multiplexed and transmitted in a single system. In this case, different transmission/reception techniques and transmission/reception parameters may be used between services to satisfy different requirements of the respective services.

There is a need in the art for a method and apparatus to smoothly provide the above-described services and to efficiently transmit a UL signal of a terminal.

### SUMMARY

The disclosure has been made to address at least the above-mentioned problems and/or disadvantages and to provide at least the advantages described below.

Accordingly, an aspect of the disclosure is to provide a device and a method capable of effectively providing services in a mobile communication system.

In accordance with an aspect of the disclosure, a method performed by a terminal in a wireless communication system includes transmitting, to a base station, a random access preamble on a physical random access channel (PRACH), and receiving, from the base station, a random access response (RAR) message including an RAR UL grant, wherein, in case that a physical UL shared channel (PUSCH) scheduled by the RAR UL grant overlaps with a physical UL control channel (PUCCH) carrying UL control information (UCI), the UCI is not multiplexed on the PUSCH.

In accordance with an aspect of the disclosure, a method performed by a base station in a wireless communication system includes receiving, from a terminal, a random access preamble on a PRACH, and transmitting, to the terminal, in response to receiving the random access preamble, an RAR message including an RAR UL grant, wherein, in case that a PUSCH scheduled by the RAR UL grant overlaps with a PUCCH carrying UCI, the UCI is not multiplexed on the PUSCH.

In accordance with an aspect of the disclosure, a terminal in a wireless communication system includes a transceiver, and at least one processor coupled with the transceiver and configured to transmit, to a base station, a random access preamble on a PRACH, and receive, from the base station, an RAR message including an RAR UL grant, wherein, in case that a PUSCH scheduled by the RAR UL grant overlaps with a PUCCH carrying UCI, the UCI is not multiplexed on the PUSCH.

In accordance with an aspect of the disclosure, a base station in a wireless communication system includes a transceiver, and at least one processor coupled with the transceiver and configured to receive, from a terminal, a random access preamble on a PRACH, and transmit, to the terminal, in response to receiving the random access preamble, an RAR message including an RAR UL grant, wherein, in case that a PUSCH scheduled by the RAR UL grant overlaps with a PUCCH carrying UCI, the UCI is not multiplexed on the PUSCH.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a frame, a subframe, and a slot in a wireless communication system according to an embodiment;

FIG. 3 illustrates a BWP configuration in a wireless communication system according to an embodiment;

FIG. 4 illustrates a control resource set (CORESET) configuration of a DL control channel in a wireless communication system according to an embodiment;

FIG. 5 illustrates a DL control channel in a wireless communication system according to an embodiment;

FIG. 6 illustrates, in terms of spans, when a UE may have multiple physical downlink control channel (PDCCH) monitoring occasions within a slot in a wireless communication system according to an embodiment;

FIG. 7 illustrates a base station beam allocation according to a transmission configuration indication (TCI) state configuration in a wireless communication system according to an embodiment;

FIG. 8 illustrates a method for allocating a TCI state to a PDCCH in a wireless communication system according to an embodiment;

FIG. 9 illustrates a TCI indication medium access control (MAC) control element (MAC CE) signaling structure for a PDCCH demodulation reference signal (DMRS) in a wireless communication system according to an embodiment;

FIG. 10 illustrates a beam configuration as to a CORESET and a search space in a wireless communication system according to an embodiment;

FIG. 11 illustrates a method in which a base station and a UE transmit/receive data in consideration of a DL data channel and a rate matching resource in a wireless communication system according to an embodiment;

FIG. 12 illustrates a method in which, upon receiving a DL control channel, a UE selects a receivable CORESET in consideration of priority in a wireless communication system according to an embodiment;

FIG. 13 illustrates an aperiodic CSI reporting method according to an embodiment;

FIG. 14 illustrates an example of PUSCH repetition type B transmission in a wireless communication system according to an embodiment;

FIG. 15 illustrates radio protocol structures of a base station and a UE in single cell, carrier aggregation, and dual connectivity situations according to an embodiment;

FIG. 16 illustrates an antenna port configuration and resource allocation for cooperative communication in a wireless communication system according to an embodiment;

FIG. 17 illustrates a DL control information (DCI) configuration for cooperative communication in a wireless communication system according to an embodiment;

FIG. 18 illustrates a procedure in which a base station controls transmission power of a UE in a cellular system according to an embodiment;

FIG. 19 illustrates a procedure in which a UE and a base station perform transmission and reception for initial connection in the wireless communication system according to an embodiment;

FIG. 20 illustrates when an Msg3 PUSCH and a PUCCH are scheduled in the wireless communication system according to an embodiment;

FIG. 21 illustrates when an Msg3 PUSCH and a PUCCH are scheduled in the wireless communication system according to an embodiment;

FIG. 22 illustrates a UL transmission signal and resource determination method of a UE in the wireless communication system according to an embodiment;

FIG. 23 illustrates a UL transmission signal and resource determination method of a UE in the wireless communication system according to an embodiment;

FIG. 24 illustrates a UL transmission signal and resource determination method of a UE in the wireless communication system according to an embodiment;

FIG. 25 illustrates a UE in a wireless communication system according to an embodiment; and

FIG. 26 illustrates a base station in a wireless communication system according to an embodiment.

### DETAILED DESCRIPTION

Hereinafter, embodiments of the disclosure will be described in detail with reference to the accompanying drawings.

Descriptions related to technical contents well-known in the relevant art and not associated directly with the disclosure will be omitted for the sake of clarity and conciseness. Such an omission of unnecessary descriptions is intended to prevent obscuring the main idea of the disclosure and more clearly convey the main idea.

For the same reason, some elements may be exaggerated, omitted, or schematically illustrated herein. The size of each element does not completely reflect the actual size, and the same or corresponding elements are assigned the same reference numerals.

In the drawings in which methods of the disclosure are described, the order of the description does not always correspond to the order in which steps of each method are performed, and the order relationship between the steps may be changed or the steps may be performed in parallel.

In addition, some or all of the contents of each embodiment may be implemented in combination without departing from the essential spirit and scope of the disclosure. The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference signs indicate the same or like elements.

The terms which will be described below are terms defined in consideration of the functions in the disclosure, and may be different according to users, intentions of the users, or customs. Therefore, the definitions of the terms should be made based on the contents throughout the specification.

Herein, a base station is an entity that allocates resources to terminals, and may be at least one of a gNode B, an eNode B, a Node B, a base station (BS), a wireless access unit, a base station controller, and a node on a network. A terminal may include a UE, an MS, a cellular phone, a smartphone, a computer, or a multimedia system capable of performing a communication function. A DL refers to a radio link via which a base station transmits a signal to a terminal, and a UL\ refers to a radio link via which a terminal transmits a signal to a base station. LTE or LTE-A systems may be described by way of example, but the embodiments of the disclosure may also be applied to other communication systems having similar technical backgrounds or channel types, such as 5th generation mobile communication technologies (5G, new radio, and NR) developed beyond LTE-A. In addition, based on determinations by those skilled in the art, the disclosure may also be applied to other communication systems through some modifications without significantly departing from the scope of the disclosure. The contents of the disclosure may be applied to frequency division duplex (FDD) and time division duplex (TDD) systems.

In embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Herein, the term unit refers to a software element or a hardware element, such as a field programmable gate array (FPGA) or an application specific integrated circuit (ASIC), and the unit may perform certain functions. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more central processing units (CPUs) within a device or a security multimedia card. The unit may include one or more processors.

### Nr Time-Frequency Resources

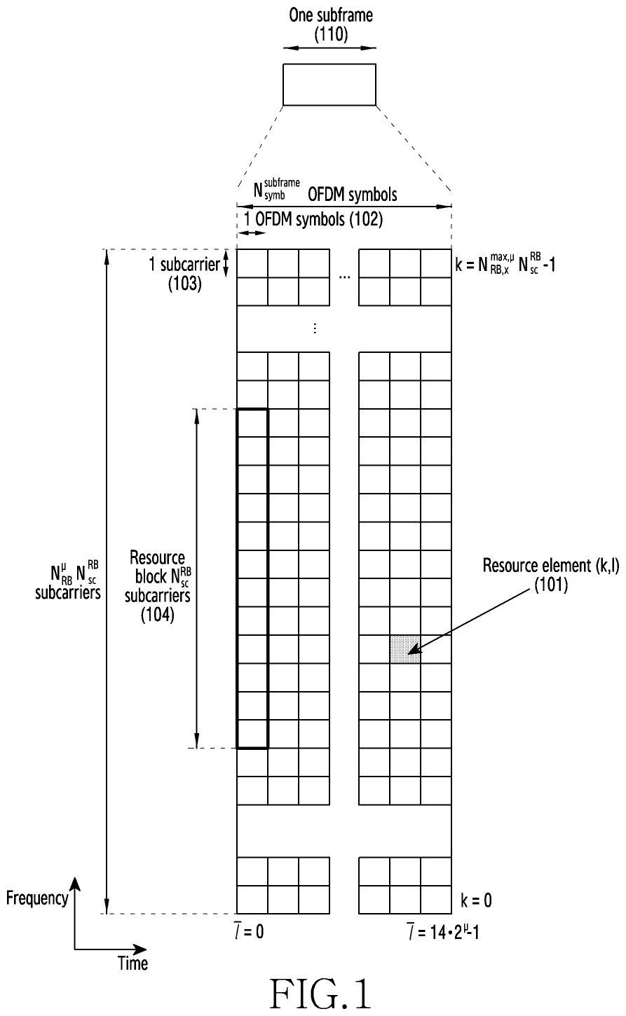

FIG. 1 illustrates a basic structure of a time-frequency domain in a wireless communication system according to an embodiment. Referring to FIG. 1, the horizontal axis represents a time domain, and the vertical axis represents a frequency domain. The basic unit of resources in the time-frequency domain is a resource element (RE) 101, which may be defined as one OFDM symbol 102 on the time axis and one subcarrier 103 on the frequency axis. In the frequency domain, N_{SC}^{RB} (e.g., 12) consecutive REs may constitute one resource block (RB) 104.

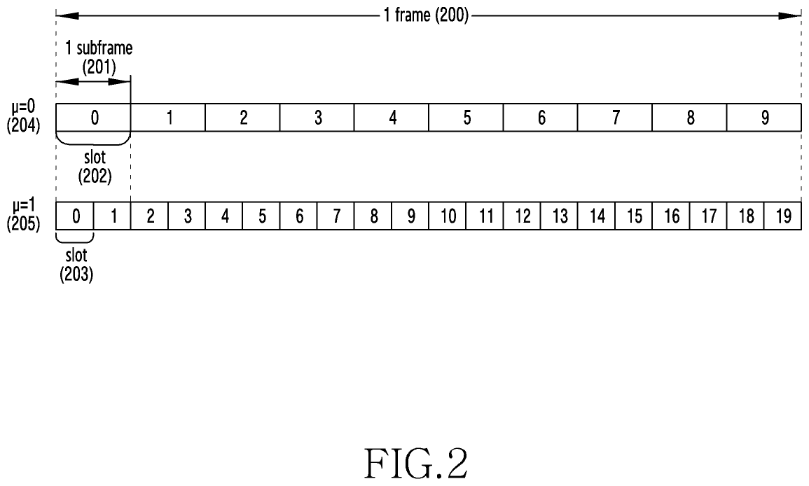

FIG. 2 illustrates a frame, a subframe, and a slot in a wireless communication system according to an embodiment.

Referring to FIG. 2, a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values μ for the subcarrier spacing 204 or 205. The example in FIG. 2 illustrates when the subcarrier spacing configuration value is u=0 (204), and when μ=1 (205). In μ=0 (204), one subframe 201 may include one slot 202, and in μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} slot may differ accordingly. Nₛₗₒₜ^{subframe,μ} and Nₛₗₒₜ^{frame,μ} slot may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

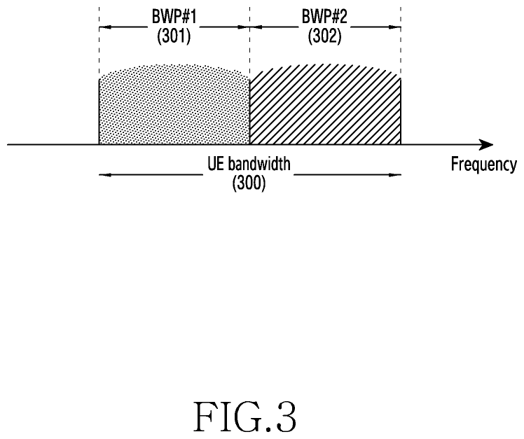

FIG. 3 illustrates a BWP configuration in a wireless communication system according to an embodiment.

FIG. 3 illustrates an example in which a UE bandwidth 300 is configured to include two BWPs, that is, BWP #1 301 and BWP #2 302. A base station may configure one or multiple BWPs for a UE and may configure the following pieces of information as to each BWP as given below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

```
    n5},
    (subcarrier spacing)
```

| | |
|---|---|
| cyclicPrefix | ENUMERATED { extended } |

(cyclic prefix)
}

The BWP configuration is not limited to the above example, and in addition to the configuration information in Table 2, various parameters related to the BWP may be configured for the UE. The base station may transfer the configuration information to the UE through upper layer signaling, such as radio resource control (RRC) signaling. One configured BWP or at least one BWP among multiple configured BWPs may be activated. Whether the configured BWP is activated may be transferred from the base station to the UE semi-statically through RRC signaling, or dynamically through DCI.

Before an RRC connection is established, an initial BWP for initial access may be configured for the UE by the base station through a master information block (MIB). More specifically, the UE may receive configuration information regarding a CORESET and a search space which may be used to transmit a PDCCH for receiving system information (SI) (which may correspond to remaining SI (RMSI) or SI block 1 (SIB1) necessary for initial access through the MIB in the initial access step. Each of the CORESET and the search space configured through the MIB may be considered identity (ID) 0. The base station may notify the UE of configuration information, such as frequency allocation information, time allocation information, and numerology, regarding control region #0 through the MIB. The base station may notify the UE of configuration information regarding the monitoring periodicity and occasion as to CORESET #0, that is, configuration information regarding search space #0, through the MIB. The UE may consider that a frequency domain configured by CORESET #0 acquired from the MIB is an initial BWP for initial access. The ID of the initial BWP may be considered 0.

The BWP-related configuration supported by 5G may be used for various purposes.

If the bandwidth supported by the UE is less than the system bandwidth, this may be supported through the BWP configuration. For example, the base station may configure the frequency location (configuration information 2) of the BWP for the UE, so that the UE can transmit/receive data at a specific frequency location within the system bandwidth.

In addition, the base station may configure multiple BWPs for the UE for supporting different numerologies. For example, to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated.

In addition, the base station may configure BWPs having different sizes of bandwidths for the UE for reducing power consumed by the UE. For example, if the UE supports a substantially large bandwidth, for example, 100 MHz, and always transmits/receives data with the corresponding bandwidth, excessive power consumption may occur. Particularly, it may be substantially inefficient from the viewpoint of power consumption to unnecessarily monitor the DL control channel with a large bandwidth of 100 MHz in the absence of traffic. To reduce power consumed by the UE, the base station may configure a BWP of a relatively small bandwidth (for example, 20 MHz) for the UE. The UE may perform a monitoring operation in the 20 MHz BWP in the absence of traffic and may transmit/receive data with the 100 MHz BWP as instructed by the base station if data has occurred.

In connection with the BWP configuring method, UEs, before RRC-connected, may receive configuration information regarding the initial BWP through an MIB in the initial access step. To be more specific, a UE may have a CORESET configured for a DL control channel which may be used to transmit DCI for scheduling an SIB from the MIB of a physical broadcast channel (PBCH). The bandwidth of the CORESET configured by the MIB may be considered as the initial BWP, and the UE may receive, through the configured initial BWP, a physical DL shared channel (PDSCH) through which an SIB is transmitted. The initial BWP may be used not only for receiving the SIB, but also for other SI (OSI), paging, random access, or the like.

### BWP Change

If a UE has one or more BWPs configured therefor, the base station may indicate, to the UE, to change (or switch or transition) the BWPs by using a BWP indicator field inside DCI. As an example, if the currently activated BWP of the UE is BWP #1 301 in FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP with no problem. To this end, requirements for the delay time (T_{BWP}) required during a BWP change are specified in standards, and may be defined given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP change delay time may support type 1 or type 2, depending on the capability of the UE. The UE may report the supportable BWP change delay time type to the base station.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the newly changed BWP. I the base station wants to schedule a data channel by using the new BWP, the base station may determine time domain resource allocation regarding the data channel, based on the UE's BWP change delay time (T_{BWP}). That is, when scheduling a data channel by using the new BWP, the base station may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value less than the BWP change delay time (T_{BWP}).

If the UE has received DCI (for example, DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (for example, the last symbol of slot n+K−1).

### SS/PBCH Block

An SS/PBCH block may refer to a physical layer channel block including a primary synchronization signal (PSS), a secondary synchronization signal (SSS), and a PBCH. Details thereof may be as follows.

PSS: A signal which becomes a reference signal for DL time/frequency synchronization, and may provide partial information of a cell ID.

SSS: A reference for DL time/frequency synchronization, and may provide the remaining cell ID information not provided by the PSS. Additionally, the SSS may serve as a reference signal for PBCH demodulation of a PBCH.

PBCH: may provide an MIB which is mandatory SI necessary for the UE to transmit/receive data channels and control channels. The mandatory SI may include search space-related control information indicating a control channel's radio resource mapping information, scheduling control information regarding a separate data channel for transmitting SI, and the like.

SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure CORESET #0 (which may correspond to a CORESET having a CORESET index of 0). The UE may monitor CORESET #0 by assuming that the DMRS transmitted in the selected SS/PBCH block and CORESET #0 are quasi-co-located (QCL). The UE may receive SI with DL control information transmitted in CORESET #0. The UE may acquire configuration information related to a RACH necessary for initial access from the received SI. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that CORESET #0 associated therewith is monitored.

### PDCCH as to DCI

In a 5G system, scheduling information regarding a PUSCH or a PDSCH may be transferred from a base station to a UE through DCI. The UE may monitor, as to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a PDCCH after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or RAR. That is, the RNTI may not be explicitly transmitted, but may be transmitted while being included in a CRC calculation process. Upon receiving a DCI message transmitted through the PDCCH, the UE may identify the CRC by using the allocated RNTI. If the CRC identification result is correct, the UE may know that the corresponding message has been transmitted to the UE.

For example, DCI for scheduling a PDSCH regarding SI may be scrambled by an SI-RNTI. DCI for scheduling a PDSCH regarding an RAR message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4

```
  - Identifier for DCI formats - [1] bit
  - Frequency domain resource assignment -[┌log₂( N_{RB}^{UL,BWP}
(N_{RB}^{UL,BWP} + 1)/ 2)┐ ] bits
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - TPC command for scheduled PUSCH - [2] bits
  - UL/ supplementary UL (UL/SUL) indicator - 0 or 1 bit
```

DCI format 0_1 may be used as non-fallback DCI for scheduling a PUSCH, and in this case, the CRC may be scrambled by a C-RNTI DCI format 0_1 in which the CRC is scrambled by a C-RNTI may include the following pieces of information, for example.

TABLE 5

| - | Carrier indicator-0 or 3 bits | | |
|---|---|---|---|
| - | UL/SUL indicator-0 or 1 bit | | |
| - | Identifier for DCI formats-[1] bits | | |
| - | BWP indicator-0, 1 or 2 bits | | |
| - | Frequency domain resource assignment | | |
| | | * | $For resource allocation type 0 , ⌈ {N}_{RB}^{UL , BWP} / P ⌉ bits$ |
| | | * | $For resource allocation type 1 , ⌈ {log}_{2} ( {N}_{RB}^{UL , BWP} ( {N}_{RB}^{UL , BWP} + 1 ) / 2 ) ⌉ bits$ |
| - | Time domain resource assignment-1, 2, 3, or 4 bits | | |
| - | Virtual RB (VRB)-to-physical RB (PRB) mapping-0 or 1 bit, only for | | |
| | resource allocation type 1. | | |
| | | * | 0 bit if only resource allocation type 0 is configured; |
| | | * | 1 bit otherwise. |
| - | Frequency hopping flag-0 or 1 bit, only for resource allocation type 1. | | |
| | | * | 0 bit if only resource allocation type 0 is configured; |
| | | * | 1 bit otherwise. |
| | Modulation and coding scheme-5 bits | | |
| - | New data indicator-1 bit | | |
| - | Redundancy version-2 bits | | |
| - | HARQ process number-4 bits | | |
| - | 1st DL assignment index-1 or 2 bits | | |
| | | * | 1 bit for semi-static HARQ-ACK codebook; |
| | | * | 2 bits for dynamic HARQ-ACK codebook with single HARQ-ACK |
| | | | codebook. |
| - | 2nd DL assignment index-0 or 2 bits | | |
| | | * | 2 bits for dynamic HARQ-ACK codebook with two HARQ-ACK |
| | | sub-codebooks; | |
| | | * | 0 bit otherwise. |
| - | TPC command for scheduled PUSCH-2 bits | | |
| - | $SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{S R S} ) ⌉ bits$ | | |
| | | * | $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$ |
| | | transmission; | |
| | | * | ┌log2(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | CSI request-0, 1, 2, 3, 4, 5, or 6 bits |
| - | Code block group (CBG) transmission information-0, 2, 4, 6, or 8 bits |
| | Phase tracking reference signal (PTRS)-DMRS association-0 or 2 bits. |
| - | beta_offset indicator-0 or 2 bits |
| - | DMRS sequence initialization-0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 6

| - | Identifier for DCI formats - [1] bit |
|---|---|
| - | Frequency domain resource assignment - [ ┌log₂(N_{RB}^{DL,BWP} |
| (N_{RB}^{DL,BWP} + 1)/ 2)┐ ] bits | |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | DL assignment index - 2 bits |
| - | TPC command for scheduled PUCCH - [2] bits |
| - | PUCCH resource indicator - 3 bits |
| - | PDSCH-to-HARQ feedback timing indicator - [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

TABLE 7

| | |
|---|---|
| - | Carrier indicator - 0 or 3 bits |
| - | Identifier for DCI formats - [1] bits |
| - | BWP indicator - 0, 1 or 2 bits |
| - | Frequency domain resource assignment |
| | * For resource allocation type 0, ┌N_{RB}^{DL,BWP}/P┐ bits |
| | * For resource allocation type 1, ┌log₂(N_{RB}^{DL, BWP}(N_{RB}^{DL,BWP} + |
| | 1)/2)┐ bits |
| - | Time domain resource assignment -1, 2, 3, or 4 bits |
| - | VRB-to-PRB mapping - 0 or 1 bit, only for resource allocation type |
| | 1. |
| | * 0 bit if only resource allocation type 0 is configured; |
| | * 1 bit otherwise. |
| - | PRB bundling size indicator - 0 or 1 bit |
| - | Rate matching indicator - 0, 1, or 2 bits |
| - | Zero power (ZP) CSI- RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | DL assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### PDCCH: CORESET, REG, CCE, and Search Space

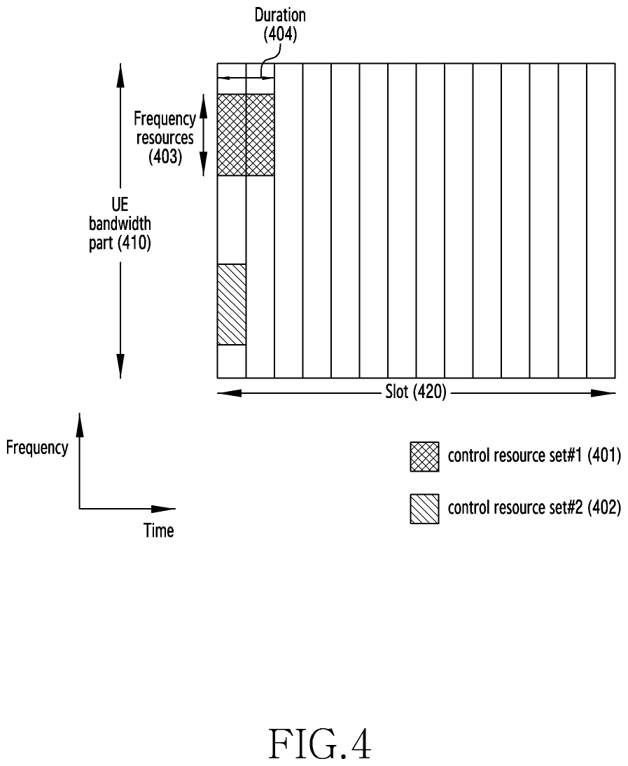

FIG. 4 illustrates a CORESET configuration as to a DL control channel in a wireless communication according to an embodiment. Referring to FIG. 4, an example is given in which a UE BWP 410 is configured along the frequency axis, and two CORESETs (CORESET #1 420 and CORESET #2 401) are configured within one slot 402 along the time axis. The CORESETs 401 and 402 may be configured in a specific frequency resource 403 within the entire UE BWP 410 along the frequency axis. The CORESETs 401 and 402 may be each configured as one or multiple OFDM symbols along the time domain, and the number of the OFDM symbols may be defined as a CORESET duration 404. CORESET #1 401 is configured to have a CORESET duration corresponding to two symbols, and CORESET #2 402 is configured to have a CORESET duration corresponding to one symbol.

A CORESET in 5G described above may be configured for a UE by a base station through upper layer signaling (for example, SI, MIB, and RRC signaling). The description that a CORESET is configured for a UE may mean that information such as a CORESET identity, the CORESET's frequency location, and the CORESET's symbol duration is provided. For example, the CORESET may include the pieces of information: given in Table 8 below.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE |

```
(45)),
    (frequency domain resource assignment information)
      duration
  INTEGER (1..maxCoReSetDuration),
    (time domain resource assignment information)
      cce-REG-MappingType
  CHOICE {
    (CCE-to-REG mapping type)
          interleaved
  SEQUENCE {
              reg-BundleSize
  ENUMERATED {n2, n3, n6},
        (REG bundle size)
              precoderGranularity
  ENUMERATED {sameAsREG-bundle, allContiguousRBs},
              interleaverSize
  ENUMERATED {n2, n3, n6}
              (interleaver size)
              shiftIndex
  INTEGER(0..maxNrofPhysicalResourceBlocks-1)
              OPTIONAL
            (interleaver shift)
      },
```

| | |
|---|---|
| nonInterleaved | NULL |

```
      },
      tci-StatesPDCCH
  SEQUENCE(SIZE (1..maxNrofTCI-StatesPDCCH)) OF TCI-StateId
          OPTIONAL,
    (QCL configuration information)
      tci-PresentInDCI
  ENUMERATED {enabled}
```

OPTIONAL, ... Need S

}

In Table 8, tci-StatesPDCCH (referred to as TCI) state) configuration information may include information of one or multiple SS/PBCH block indexes or CSI-RS indexes, which are OCLed with a DMRS transmitted in a corresponding CORESET. Obviously, the example given below is not limiting.

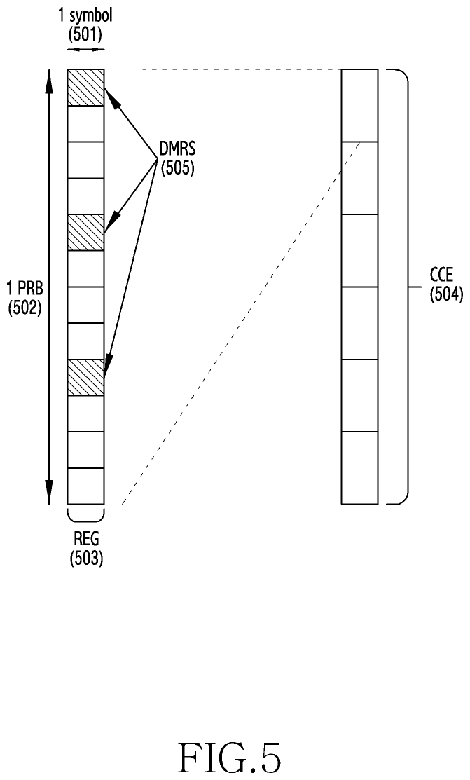

FIG. 5 illustrates a DL control channel in a wireless communication system according to an embodiment.

Referring to FIG. 5, a basic unit of time and frequency resources constituting a DL control channel available in 5G is provided. The basic unit of time and frequency resources constituting a control channel may be referred to as an RE group (REG) 503, and the REG 503 may be defined by one OFDM symbol 501 along the time axis and one PRB 502, that is, 12 subcarriers, along the frequency axis. The base station may configure a DL control channel allocation unit by concatenating the REGs 503.

Provided that the basic unit of DL control channel allocation in 5G is a control channel element 504 as illustrated in FIG. 5, one CCE 504 may include multiple REGs 503. The REG 503 may include 12 REs, and if one CCE 504 includes six REGs 503, one CCE 504 may then include 72 REs. A DL CORESET, once configured, may include multiple CCEs 504, and a specific DL control channel may be mapped to one or multiple CCEs 504 and then transmitted according to the aggregation level (AL) in the CORESET. The CCEs 504 in the CORESET are distinguished by numbers, and the numbers of CCEs 504 may be allocated according to a logical mapping scheme.

The basic unit of the DL control channel illustrated in FIG. 5, that is, the REG 503, may include both REs to which DCI is mapped, and an area to which a demodulation reference signal (DMRS) 505 for decoding the same is mapped. In FIG. 5, three DMRSs 503 may be transmitted inside one REG 505. The number of CCEs necessary to transmit a PDCCH may be 1, 2, 4, 8, or 16 according to the aggregation level (AL), and different number of CCEs may be used to implement link adaption of the DL control channel. For example, in AL=L, one DL control channel may be transmitted through L CCEs. The UE needs to detect a signal while being no information regarding the DL control channel, and thus a search space indicating a set of CCEs has been defined for blind decoding. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH to receive cell-common control information such as dynamic scheduling regarding SI or a paging message. For example, PDSCH scheduling allocation information for transmitting an SIB including a cell operator information or the like may be received by searching the common search space of the PDCCH. In a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion as to each symbol in a slot regarding the search space, the search space type (common search space or UE-specific search space), a combination of an RNTI and a DCI format to be monitored in the corresponding search space, a CORESET index for monitoring the search space, and the like. For example, the following pieces of information may be included.

TABLE 9

| | |
|---|---|
| SearchSpace ::= | SEQUENCE { |

```
  -- Identity of the search space. SearchSpaceId = 0 identifies the SearchSpace configured
  via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

```
    (monitoring slot level periodicity)
        sl1
      NULL,
        sl2
      INTEGER (0..1),
        sl4
      INTEGER (0..3),
        sl5
      INTEGER (0..4),
        sl8
      INTEGER (0..7),
        sl10
      INTEGER (0..9),
        sl16
      INTEGER (0..15),
        sl20
      INTEGER (0..19)
      }
```

| | |
|---|---|
| | OPTIONAL, |
| duration (monitoring duration) | INTEGER (2..2559) |
| monitoringSymbolsWithinSlot | BIT STRING |

```
(SIZE (14))
        OPTIONAL,
    (monitoring symbols within slot)
```

| | |
|---|---|
| nrofCandidates | SEQUENCE { |

```
    (number of PDCCH candidates for each aggregation level)
        aggregationLevel1
      ENUMERATED {n0, n1, n2, n3, n4, n5, n6, n8},
        aggregationLevel2
      ENUMERATED {n0, n1, n2, n3, n4, n5, n6, n8},
        aggregationLevel4
      ENUMERATED {n0, n1, n2, n3, n4, n5, n6, n8},
        aggregationLevel8
      ENUMERATED {n0, n1, n2, n3, n4, n5, n6, n8},
        aggregationLevel16
      ENUMERATED {n0, n1, n2, n3, n4, n5, n6, n8}
      },
```

| | |
|---|---|
| searchSpaceType | CHOICE { |

```
      (search space type)
        -- Configures this search space as common search space (CSS) and DCI
formats to monitor.
        common
      SEQUENCE {
      (common search space)
      }
        ue-Specific
      SEQUENCE {
      UE-specific search space (USS)
          -- Indicates whether the UE monitors in this USS for DCI formats 0-
0 and 1-0 or for formats 0-1 and 1-1.
          formats
```

| | |
|---|---|
| ENUMERATED {formats0-0-And-1-0, | formats0-1-And-1-1}, |

...
}

According to configuration information, the base station may configure one or multiple search space sets for the UE. The base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.
Combinations of DCI formats and RNTIs given below may be monitored in a common search space. Obviously, the examples given below are not limiting.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

Combinations of DCI formats and RNTIs given below may be monitored in a UE-specific search space. Obviously, the examples given below are not limiting.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

SI-RNTI: used to schedule a PDSCH in which SI is transmitted

Interruption RNTI (INT-RNTI): used to indicate whether a PDSCH is punctured

TPC-PUSCH-RNTI used to indicate a power control command regarding a PUSCH

TPC-PUCCH-RNTI used to indicate a power control command regarding a PUCCH

TPC-SRS-RNTI used to indicate a power control command regarding an SRS

The DCI formats enumerated above may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be provided by the following by Equation (1) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

L: aggregation level
   n_{CI}: carrier index
      N_{CCE,p}: total number of CCEs existing in CORESET p
      n_{s,f}^{μ}: slot index
   M_{s,max}^{(L)}: number of PDCCH candidates at aggregation level L
      m_{s,n}_{_{CI}}=0, . . . , M_{s,max}^{(L)}−1: PDCCH candidate index at aggregation level L
      i=0, . . . , L−1

$${Y}_{p , {n}_{s , f}^{μ}} = ( {A}_{p} \cdot {Y}_{p , {n}_{s , f}^{μ} - 1} )$$

mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{μ}}$$

a common search space.

The

$${Y}_{p , {n}_{s , f}^{μ}}$$

value changed by the UE's identity (C-RNTI or ID configured for the UE by the base station) and the time index in a UE-specific search space.

In a 5G system, multiple search space sets may be configured by different parameters such as those in Table 10 above, and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### PDCCH: Span

The UE in 5G may perform UE capability reporting at each subcarrier spacing as to when the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be described by (X, Y) wherein X refers to the minimum number of symbols by which the first symbols of two consecutive spans are spaced apart from each other, and Y refers to the number of consecutive symbols configured such that the PDCCH can be monitored inside one span. Here, a UE may monitor a PDCCH in a range of Y symbols from the first symbol of the span within the span.

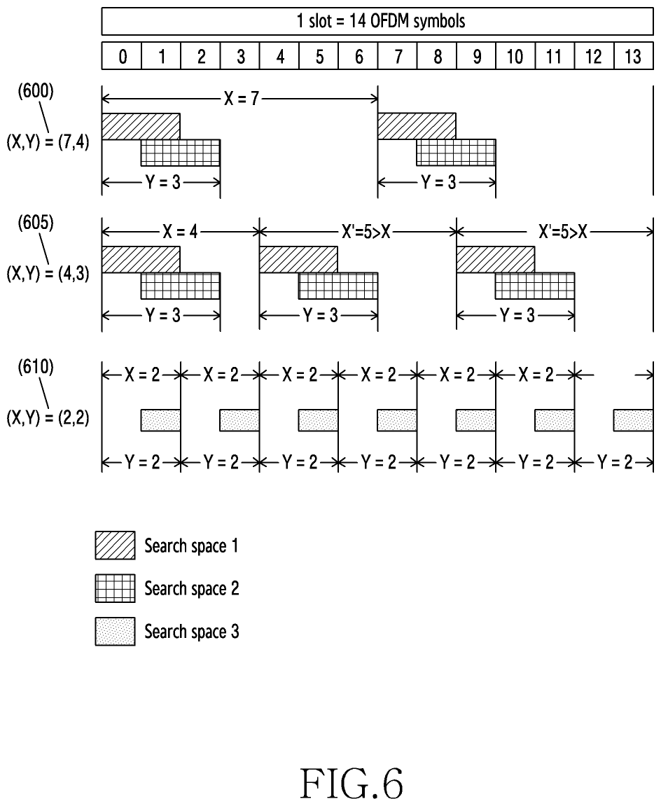

FIG. 6 illustrates, in terms of spans, when a UE may have multiple PDCCH monitoring occasions within a slot in a wireless communication system according to an embodiment. Possible spans are (X,Y)=(7,3), (4,3), (2,2), and the three cases may be indicated by “600”, “605”, and “610” in FIG. 6, respectively. As an example, “600” may describe when there are two spans described by (7,4) inside a slot. The spacing between the first symbols of two spans in FIG. 6 is described as X=7, a PDCCH monitoring occasion may exist inside a total of Y=3 symbols from the first symbol of each span, and search spaces 1 and 2 may exist inside Y=3 symbols, respectively. As another example, “605” may describe when there are a total of three spans described by (4,3) inside a slot, and the second and third spans are spaced apart by X′=5 symbols which are greater than X=4. As another example, “610” may describe when there are a total of three spans described by (2,2) inside a slot. The spacing between all spans in FIG. 6 is described as X=2, search spaces 3 may exist inside Y=2 symbols.

### Pdcch: UE Capability Report

The slot location at which the above-described common search space and the UE-specific search space are positioned is indicated by parameter “monitoringSymbolsWitninSlot” in Table 13-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.

UE capability 1 (hereinafter interchangeably used with FG 3-1). This UE capability may have the following meaning: if there is one monitoring occasion (MO) regarding type 1 and type 3 common search spaces or UE-specific search spaces inside a slot, as in Table 11 below, the UE can monitor the corresponding MO when the corresponding MO is located inside the first three symbols within the slot. UE capability 1 is a mandatory capability which is to be supported by all UEs that support NR, and whether UE capability 1 is supported may not be explicitly reported to the base station.

TABLE 11

| | Feature | | Field name in |
|---|---|---|---|
| Index | group | Components | TS 38.331 [2] |
| 3-1 | Basic DL | 1) One configured CORESET per BWP per cell in | n/a |
| | control | addition to CORESET0 | |
| | channel | CORESET resource allocation of 6RB bit-map | |
| | | and duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map | |
| | | and duration 1-3 OFDM symbols for FR2 | |
| | | For type 1 CSS with dedicated RRC | |
| | | configuration and for type 3 CSS, UE specific SS, | |
| | | CORESET resource allocation of 6RB bit-map | |
| | | and duration 1-2 OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a | |
| | | scheduled SCell per BWP | |
| | | This search space limit is before applying all | |
| | | dropping rules. | |
| | | For type 1 CSS with dedicated RRC | |
| | | configuration, type 3 CSS, and UE-SS, the | |
| | | monitoring occasion is within the first 3 OFDM | |
| | | symbols of a slot | |
| | | For type 1 CSS without dedicated RRC | |
| | | configuration and for type 0, OA, and 2 CSS, the | |
| | | monitoring occasion can be any OFDM symbol(s) | |
| | | of a slot, with the monitoring occasions for any of | |
| | | Type 1- CSS without dedicated RRC | |
| | | configuration, or Types 0, 0A, or 2 CSS | |
| | | configurations within a single span of three | |
| | | consecutive OFDM symbols within a slot | |
| | | 3) Monitoring DCI formats 0_0, 1_0, 0_1, 1_1 | |
| | | 4) Number of PDCCH blind decodes per slot with | |
| | | a given SCS follows Case 1-1 table | |
| | | 5) Processing one unicast DCI scheduling DL and | |
| | | one unicast DCI scheduling UL per slot per | |
| | | scheduled CC for FDD | |
| | | 6) Processing one unicast DCI scheduling DL and | |
| | | 2 unicast DCI scheduling UL per slot per | |
| | | scheduled CC for TDD | |

UE capability 2 (hereinafter interchangeably used with FG 3-2). This UE capability has the following meaning: if there is one MO regarding a common search space or a UE-specific search space inside a slot, as in Table 12 below, the UE can monitor the corresponding MO no matter what of the start symbol location of the corresponding MO may be. UE capability 2 is optionally supported by the UE, and whether UE capability 2 is supported may be explicitly reported to the base station.

TABLE 12

| | Feature | | |
|---|---|---|---|
| Index | group | Components | Field name in TS 38.331 [2] |
| 3-2 | PDCCH monitoring | For a given UE, all search space | pdcchMonitoringSingleOccasion |
| | on any span of up | configurations are within the same | |
| | to 3 consecutive | span of 3 consecutive OFDM | |
| | OFDM symbols | symbols in the slot | |
| | of a slot | | |

This UE capability has the following meaning: if there are multiple MO's regarding a common search space or a UE-specific search space inside a slot, as in Table 13 below, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. UE capability 3 is optionally supported by the UE, and whether UE capability 3 is supported and the above-mentioned combination of (X,Y) are explicitly reported to the base station.

TABLE 13

| | Feature | | Field name in |
|---|---|---|---|
| Index | group | Components | TS 38.331 [2] |
| 3-5 | For type 1 | For type 1 CSS with dedicated RRC | pdcch- |
| | CSS with | configuration, type 3 CSS, and UE- | MonitoringAnyOccasions |
| | dedicated | SS, monitoring occasion can be any | { |
| | RRC | OFDM symbol(s) of a slot for Case 2 | 3-5. withoutDCI-Gap |
| | configuration, | | 3-5a. withDCI-Gap |
| | type 3 CSS, | | } |
| | and UE-SS, | | |
| | monitoring | | |
| | occasion can | | |
| | be any | | |
| | OFDM | | |
| | symbol(s) of | | |
| | a slot for | | |
| | Case 2 | | |
| 3-5a | For type 1 | For type 1 CSS with dedicated RRC | |
| | CSS with | configuration, type 3 CSS and UE- | |
| | dedicated | SS, monitoring occasion can be any | |
| | RRC | OFDM symbol(s) of a slot for Case | |
| | configuration, | 2, with minimum time separation | |
| | type 3 CSS, | (including the cross-slot boundary | |
| | and UE-SS, | case) between two DL unicast DCIs, | |
| | monitoring | between two UL unicast DCIs, or | |
| | occasion can | between a DL and an UL unicast DCI | |
| | be any | in different monitoring occasions | |
| | OFDM | where at least one of them is not the | |
| | symbol(s) of | monitoring occasions of FG-3-1, for | |
| | a slot for | a same UE as | |
| | Case 2 with a | 2OFDM symbols for 15 kHz | |
| | DCI gap | 4OFDM symbols for 30 kHz | |
| | | 7OFDM symbols for 60 kHz with NCP | |
| | | 11OFDM symbols for 120 kHz | |
| | | Up to one unicast DL DCI and up to | |
| | | one unicast UL DCI in a monitoring | |
| | | occasion except for the monitoring | |
| | | occasions of FG 3-1. | |
| | | In addition for TDD the minimum | |
| | | separation between the first two UL | |
| | | unicast DCIs within the first 3 | |
| | | OFDM symbols of a slot can be zero | |
| | | OFDM symbols. | |
| 3-5b | All PDCCH | PDCCH monitoring occasions of FG- | |
| | monitoring | 3-1, plus additional PDCCH | |
| | occasion can | monitoring occasion(s) can be any | |
| | be any | OFDM symbol(s) of a slot for Case | |
| | OFDM | 2, and for any two PDCCH | |
| | symbol(s) of | monitoring occasions belonging to | |
| | a slot for | different spans, where at least one of | |
| | Case 2 with a | them is not the monitoring occasions | |
| | span gap | of FG-3-1, in same or different search | |
| | | spaces, there is a minimum time | |
| | | separation of X OFDM symbols | |
| | | (including the cross-slot boundary | |
| | | case) between the start of two spans, | |
| | | where each span is of length up to Y | |
| | | consecutive OFDM symbols of a slot. | |
| | | Spans do not overlap. Every span is | |
| | | contained in a single slot. The same | |
| | | span pattern repeats in every slot. The | |
| | | separation between consecutive spans | |
| | | within and across slots may be | |
| | | unequal but the same (X, Y) limit | |
| | | must be satisfied by all spans. | |
| | | Every monitoring occasion is fully | |
| | | contained in one span. To determine | |
| | | a suitable span pattern, first a bitmap | |
| | | b(1), 0 <= 1 <= 13 is generated, where | |
| | | b(1) = 1 if symbol 1 of any slot is part | |
| | | of a monitoring occasion, b(1) = 0 | |
| | | otherwise. The first span in the span | |
| | | pattern begins at the smallest 1 for | |
| | | which b(1) = 1. The next span in the | |
| | | span pattern begins at the smallest 1 | |
| | | not included in the previous span(s) | |
| | | for which b(1) = 1. The span duration | |
| | | is max {maximum value of all | |
| | | CORESET durations, minimum | |
| | | value of Y in the UE reported | |
| | | candidate value} except possibly the | |
| | | last span in a slot which can be of | |
| | | shorter duration. A particular | |
| | | PDCCH monitoring configuration | |
| | | meets the UE capability limitation if | |
| | | the span arrangement satisfies the gap | |
| | | separation for at least one (X, Y) in | |
| | | the UE reported candidate value set | |
| | | in every slot, including cross slot | |
| | | boundary. | |
| | | For the set of monitoring occasions | |
| | | which are within the same span: | |
| | | Processing one unicast DCI | |
| | | scheduling DL and one unicast DCI | |
| | | scheduling UL per scheduled CC | |
| | | across this set of monitoring | |
| | | occasions for FDD | |
| | | Processing one unicast DCI | |
| | | scheduling DL and two unicast DCI | |
| | | scheduling UL per scheduled CC | |
| | | across this set of monitoring | |
| | | occasions for TDD | |
| | | Processing two unicast DCI | |
| | | scheduling DL and one unicast DCI | |
| | | scheduling UL per scheduled CC | |
| | | across this set of monitoring | |
| | | occasions for TDD | |
| | | The number of different start symbol | |
| | | indices of spans for all PDCCH | |
| | | monitoring occasions per slot, | |
| | | including PDCCH monitoring | |
| | | occasions of FG-3-1, is no more than | |
| | | floor(14/X) (X is minimum among | |
| | | values reported by UE). | |
| | | The number of different start symbol | |
| | | indices of PDCCH monitoring | |
| | | occasions per slot including PDCCH | |
| | | monitoring occasions of FG-3-1, is | |
| | | no more than 7. | |
| | | The number of different start symbol | |
| | | indices of PDCCH monitoring | |
| | | occasions per half-slot including | |
| | | PDCCH monitoring occasions of FG- | |
| | | 3-1 is no more than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned where the UE cannot monitor the same.

### QCL, TCI State

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a QCL configuration as in Table 14 below. A TCI state is for announcing the QCL relation between a PDCCH (or a PDCCH DMRS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 14 below.

TABLE 14

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 15 below. Referring to Table 15, the base station may configure one or more TCI states for the UE, thereby informing of a maximum of two types of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 14 above.

TABLE 15

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring
to corresponding TCI state ID)

| | |
|---|---|
| qcl-Type2 | QCL-Info |

```
        OPTIONAL, -- Need R
  (QCL information of second reference RS of RS (target RS) referring
to corresponding TCI state ID)
  ...
}
```

| | |
|---|---|
| QCL-Info ::= | SEQUENCE { |
| cell | ServCellIndex |

```
      OPTIONAL, -- Need R
  (serving cell index of reference RS indicated by corresponding QCL
information)
```

| | |
|---|---|
| bwp-Id | BWP-Id |

```
          OPTIONAL, -- Cond CSI-RS-Indicated
  (BWP index of reference RS indicated by corresponding QCL
  information)
```

| | |
|---|---|
| referenceSignal | CHOICE { |
| csi-rs | NZP- |

```
CSI-RS-ResourceId,
    ssb
  SSB-Index
    (one of CSI-RS ID or SSB ID indicated by corresponding QCL
information)
  },
```

| | |
|---|---|
| qcl-Type | ENUMERATED |

{typeA, typeB, typeC, typeD},
...
}

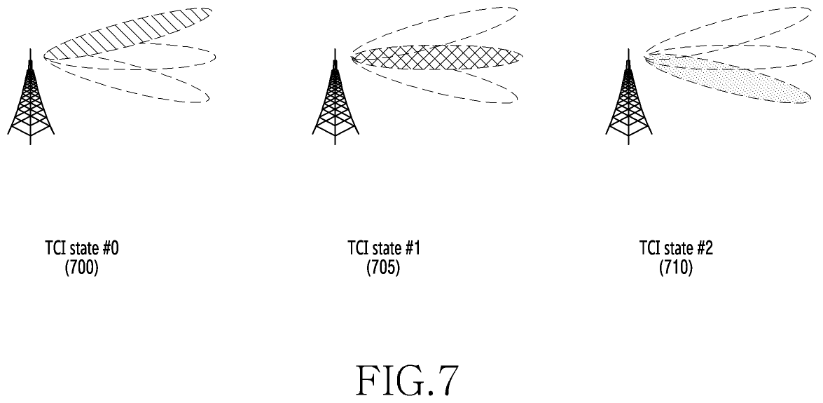

FIG. 7 illustrates an example of base station beam allocation according to TCI state configuration in a wireless communication system according to an embodiment.

Referring to FIG. 7, the base station may transfer information regarding N different beams to the UE through N different TCI states. For example, in N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Tables 16 to 20 below enumerate valid TCI state configurations according to the target antenna port type.

Table 16 enumerates valid TCI state configurations when the target antenna port is a CSI-RS for tracking (TRS). The TRS may refer to an NZP CSI-RS which has no repetition parameter configured therefor, and trs-Info of which is configured as “true”, among CRI-RSs. In Table 16, configuration no. 3 may be used for an aperiodic TRS.

TABLE 16

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same | QCL-TypeD |
| | (periodic) | | as DL RS 1) | |

Table 17 below enumerates valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CRI-RSs.

TABLE 17

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS | QCL-TypeD |
| | | | for BM | |
| 3 | TRS | QCL-TypeA | TRS (same | QCL-TypeD |
| | | | as DL RS 1) | |
| 4 | TRS | QCL-TypeB | | |

Table 18 below enumerates valid TCI state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs.

TABLE 18

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 19 below enumerates valid TCI state configurations when the target antenna port is a PDCCH DMRS.

TABLE 19

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | | | as DL RS 1) | |

Table 20 enumerates valid TCI state configurations when the target antenna port is a PDSCH DMRS.

TABLE 20

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS | QCL-TypeD |

According to a representative QCL configuration method based on Tables 16 to 20 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

### PDCCH as to TCI State

Specific TCI state combinations applicable to a PDCCH DMRS antenna port may be given in Table 21 below. The fourth row in Table 21 corresponds to a combination assumed by the UE before RRC configuration, and no configuration is possible after the RRC.

TABLE 21

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| 4 | SS/PBCH | QCL-TypeA | SS/PBCH | QCL-TypeD |
| | Block | | Block | |

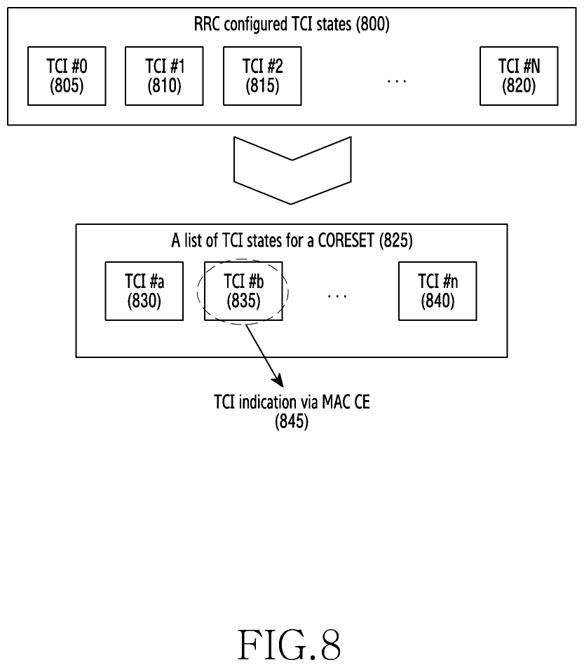

FIG. 8 illustrates a method for allocating a TCI state to a PDCCH in a wireless communication system according to an embodiment.

In NR, a hierarchical signaling method as illustrated in FIG. 8 is supported for dynamic allocation regarding a PDCCH beam. Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

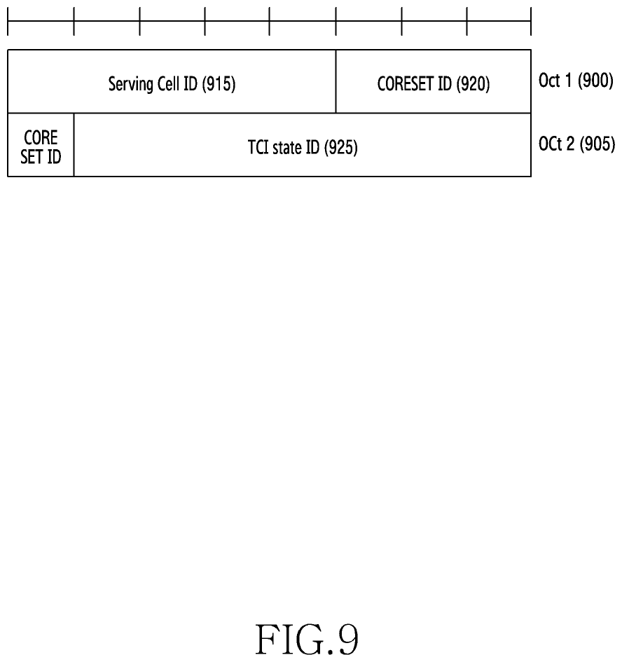

FIG. 9 illustrates a TCI indication MAC CE signaling structure for a PDCCH DMRS in a wireless communication system according to an embodiment.

Referring to FIG. 9, the TCI indication MAC CE signaling for the PDCCH DMRS may be configured by 2 bytes (16 bits), and include a 5-bit serving cell ID 915, a 4-bit CORESET ID 920 in Octet 1 (900), and a 7-bit TCI state ID 925 in Octet 2 (905).

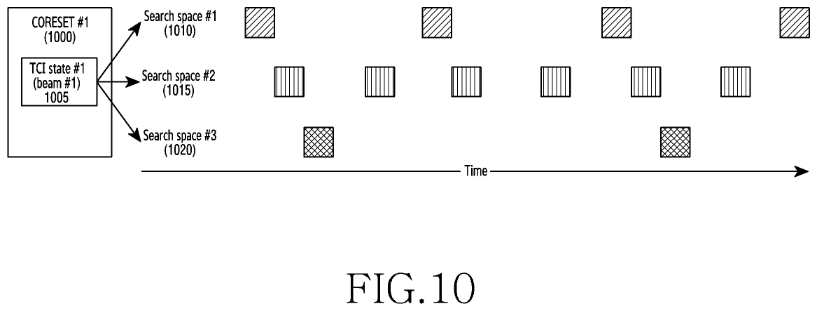

FIG. 10 illustrates an example of beam configuration as to a CORESET and a search space according to an embodiment. Referring to FIG. 10, the base station may indicate one of TCI state lists included in CORESET 1000 configuration through MAC CE signaling. Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE as to a specific CORESET and may activate one of the configured TCI states through a MAC CE activation command. For example, if {TCI state #0, TCI state #1, TCI state #2} are configured as TCI states for CORESET #1, the base station may transmit an activation command to the UE through a MAC CE such that TCI state #0 is assumed as the TCI state regarding CORESET #1. Based on the activation command regarding the TCI state received through the MAC CE, the UE may correctly receive the DMRS of the corresponding CORESET, based on QCL information in the activated TCI state.

As to a CORESET having a configured index of 0 (CORESET #0), if the UE has failed to receive a MAC CE activation command regarding the TCI state of CORESET #0, the UE may assume that the DMRS transmitted in CORESET #0 has been QCL-ed with a SS/PBCH block identified in the initial access process, or in a non-contention-based random access process not triggered by a PDCCH command.

As to a CORESET having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### Pdcch as to QCL Prioritization Rule

If multiple CORESETs which operate according to carrier aggregation inside a single cell or band and which exist inside a single or multiple in-cell activated BWPs overlap temporally while having identical or different QCL-TypeD characteristics in a specific PDCCH monitoring occasion, the UE may select a specific CORESET according to a QCL priority determining operation and may monitor CORESETs having the same QCL-TypeD characteristics as the corresponding CORESET. That is, if multiple CORESETs overlap temporally, only one QCL-TypeD characteristic can be received. The QCL priority may be determined by the following criteria.

Criterion 1: A CORESET connected to a common search space having the lowest index inside a cell corresponding to the lowest index among cells including a common search space

Criterion 2: A CORESET connected to a UE-specific search space having the lowest index inside a cell corresponding to the lowest index among cells including a UE-specific search space

As described above, if one criterion among the criteria is not satisfied, the next criterion may be applied. For example, if CORESETs overlap temporally in a specific PDCCH monitoring occasion, and if all CORESETs are not connected to a common search space but connected to a UE-specific search space (for example, if criterion 1 is not satisfied), the UE may omit application of criterion 1 and apply criterion 2.

If selecting CORESET according to the above-mentioned criteria, the UE may additionally consider the two aspects as to QCL information configured for the CORESET. First, if CORESET 1 has CSI-RS 1 as a reference signal having a relation of QCL-TypeD, if this CSI-RS 1 has a relation of QCL-TypeD with reference signal SSB 1, and if another CORESET 2 has a relation of QCL-TypeD with reference signal SSB 1, the UE may determine or consider that the two CORESETs 1 and 2 have different QCL-TypeD characteristics. Secondly, if CORESET 1 has CSI-RS 1 configured for cell 1 as a reference signal having a relation of QCL-TypeD, if this CSI-RS 1 has a relation of QCL-TypeD with reference signal SSB 1, if CORESET 2 has a relation of QCL-TypeD with reference signal CSI-RS 2 configured for cell 2, and if this CSI-RS 2 has a relation of QCL-TypeD with the same reference signal SSB 1, the UE may determine or consider that the two CORESETs have the same QCL-TypeD characteristics.

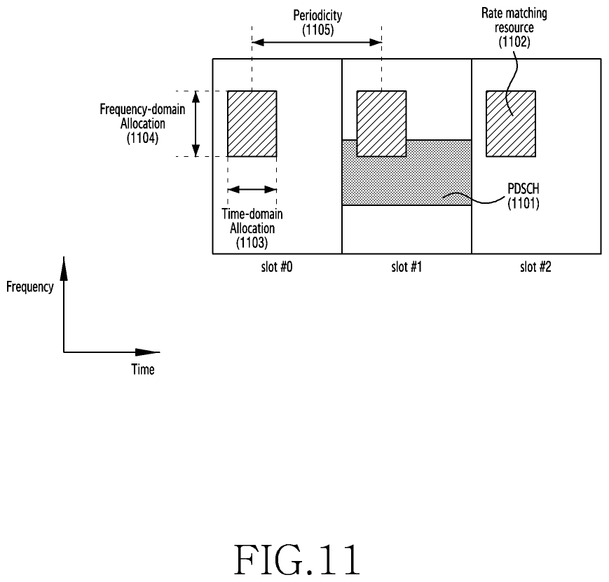

FIG. 11 illustrates a method in which a base station and a UE transmit/receive data in consideration of a DL data channel and a rate matching resource in a wireless communication system according to an embodiment.

Referring to FIG. 11, a PDSCH 1101 and a rate matching resource 1102 are illustrated. The base station may configure one or multiple rate matching resources 1102 for the UE through upper layer signaling (for example, RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 1102, the base station may rate-match and transmit the PDSCH 1101 in a rate matching resource 1102 part, and the UE may perform reception and decoding after assuming that the PDSCH 1101 has been rate-matched in a rate matching resource 1102 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched as to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, when rate matching is to be conducted, the base station may indicate this case by “1”, and when rate matching is not to be conducted, the base station may indicate this case by “0”.

5G supports granularity of RB symbol level and RE level as a method for configuring the above-described rate matching resources for a UE.

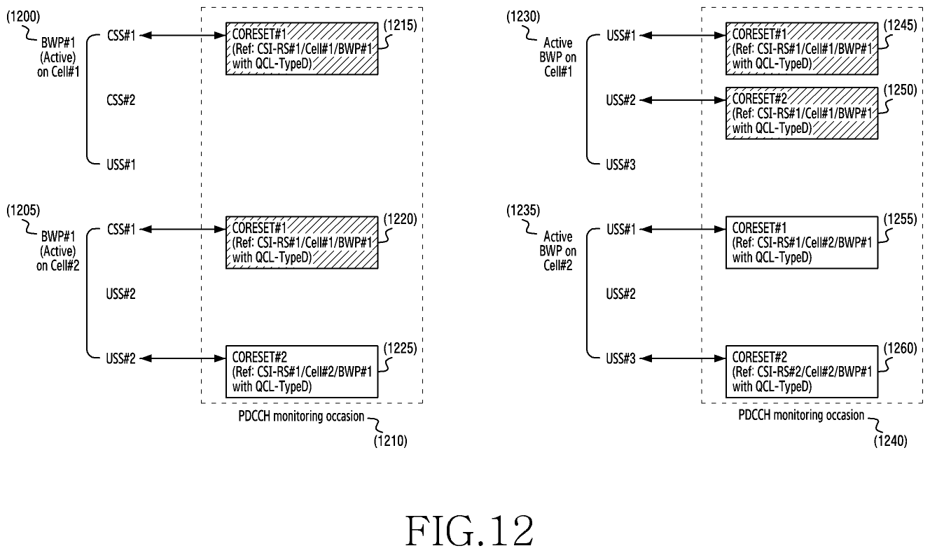

FIG. 12 illustrates a method in which, upon receiving a DL control channel, a UE selects a receivable CORESET in consideration of priority in a wireless communication system according to an embodiment. Referring to FIG. 12, the UE may be configured to receive multiple CORESETs overlapping temporally in a specific PDCCH monitoring occasion 1210, and such multiple CORESETs may be connected to a common search space or a UE-specific search space as to multiple cells. In the corresponding PDCCH monitoring occasion, CORESET no. 1 1200 connected to common search space no. 1 may exist in BWP no. 1 1215 of cell no. 1, and CORESET no. 1 1205 connected to common search space no. 1 and CORESET no. 2 1220 connected to UE-specific search space no. 2 may exist in BWP no. 1 1225 of cell no. 2. The CORESETs 1215 and 1220 may have a relation of QCL-TypeD with CSI-RS resource no. 1 configured in BWP no. 1 of cell no. 1, and the CORESET 1225 may have a relation of QCL-TypeD with CSI-RS resource no. 1 configured in BWP no. 1 of cell no. 2. If criterion 1 is applied to the corresponding PDCCH monitoring occasion 1210, all other CORESETs having the same reference signal of QCL-TypeD as CORESET no. 1 1215 may be received. Therefore, the UE may receive the CORESETs 1210 and 1215 in the corresponding PDCCH monitoring occasion 1220. As another example, the UE may be configured to receive multiple CORESETs overlapping temporally in a specific PDCCH monitoring occasion 1240, and such multiple CORESETs may be connected to a common search space or a UE-specific search space as to multiple cells. In the corresponding PDCCH monitoring occasion, CORESET no. 1 1230 connected to UE-specific search space no. 1 and CORESET no. 2 1245 connected to UE-specific search space no. 2 may exist in BWP no. 1 1250 of cell no. 1, and CORESET no. 1 1235 connected to UE-specific search space no. 1 and CORESET no. 2 1255 connected to UE-specific search space no. 3 may exist in BWP no. 1 1260 of cell no. 2. The CORESETs 1245 and 1250 may have a relation of QCL-TypeD with CSI-RS resource no. 1 configured in BWP no. 1 of cell no. 1, the CORESET 1255 may have a relation of QCL-TypeD with CSI-RS resource no. 1 configured in BWP no. 1 of cell no. 2, and the CORESET 1260 may have a relation of QCL-TypeD with CSI-RS resource no. 2 configured in BWP no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other CORESETs having the same reference signal of QCL-TypeD as CORESET no. 1 1245 may be received. Therefore, the UE may receive the CORESETs 1240 and 1245 in the corresponding PDCCH monitoring occasion 1250.

### Rate Matching/Puncturing

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively. Obviously, the example given above is not limiting.

### Puncturing

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission as to only the remaining resource area other than resource C among resource A. For example, if symbol sequence A is configured as {symbol #1, symbol #2, symbol #3, symbol4}, resource A is {resource #1, resource #2, resource #3, resource #4}, and resource B is {resource #3, resource #5}, the base station may map symbol sequence {symbol #1, symbol #2, symbol #3, symbol #4} to resource A {resource #1, resource #2, resource #3, respectively, may transmit only symbol sequence {symbol #1, symbol #2, symbol #4} corresponding to remaining resources {resource #1, resource #2, resource #4} other than {resource #3} (corresponding to resource C) among resource A, and may not transmit {symbol #3} mapped to {resource #3} (corresponding to resource C). Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Rate matching refers to adjusting the size of a signal in consideration of the amount of resources that can be used to transmit the signal. For example, data channel rate matching may mean that a data channel is not mapped and transmitted as to specific time and frequency resource domains, and the size of data is adjusted accordingly.

### Rb Symbol Level

The UE may have a maximum of four RateMatchPatterns configured per each BWP through upper layer signaling, and one RateMatchPattern may include the following contents.

may include, in connection with a reserved resource inside a BWP, a resource having time and frequency resource domains of the corresponding reserved resource configured as a combination of an RB-level bitmap and a symbol-level bitmap in the frequency domain. The reserved resource may span one or two slots. A time domain pattern (periodicity And Pattern) may be additionally configured wherein time and frequency domains including respective RB-level and symbol-level bitmap pairs are repeated.

may include a resource area corresponding to a time domain pattern configured by time and frequency domain resource areas configured by a CORESET inside a BWP and a search space configuration in which corresponding resource areas are repeated.

### RE Level

The UE may have the following contents configured through upper layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple ZP CSI-RSs inside a BWP.

### LTE CRS Rate Match

In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig information element (IE) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR may provide a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific PDSCH or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 22 below shows a ServingCellConfig IE including the CRS patterns, and Table 23 shows a RateMatchPatternLTE-CRS IE including at least one parameter regarding CRS patterns.

TABLE 22

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) |
| OF BWP-Id | OPTIONAL, -- Need N |
| downlinkBWP-ToAddModList | SEQUENCE (SIZE |
| (1..maxNrofBWPs)) OF BWP-Downlink | OPTIONAL, -- |

Need N

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, |

ms4, ms5, ms6, ms8, ms10, ms20, ms30,
ms40,ms50, ms60, ms80,ms100, ms200,ms300, ms500,
ms750, ms1280, ms1920, ms2560, spare10, spare9, spare8,

| | |
|---|---|
| spare7, spare6, spare5, spare4, spare3, spare2, spare1 } | OPTIONAL, -- Need R |
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH- |
| ServingCellConfig } | OPTIONAL, -- Need M |
| pdsch-ServingCellConfig | SetupRelease { PDSCH- |
| ServingCellConfig } | OPTIONAL, -- Need M |
| csi-MeasConfig | SetupRelease { CSI- |
| MeasConfig } | OPTIONAL, -- Need |

M

| | |
|---|---|
| sCellDeactivationTimer | ENUMERATED {ms20, |

ms40, ms80, ms160, ms200, ms240,
ms320, ms400, ms480, ms520, ms640, ms720,

| | |
|---|---|
| ms840, ms1280, spare2, spare1} | OPTIONAL, -- Cond |

ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |

dummy
ENUMERATED {enabled}
OPTIONAL, -- Need R

| | |
|---|---|
| pathlossReferenceLinking | ENUMERATED {spCell, |
| sCell} | OPTIONAL, -- Cond |

SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { |
| RateMatchPatternLTE-CRS } | OPTIONAL, -- |

Need M

| | |
|---|---|
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| downlinkChannelBW-PerSCS-List | SEQUENCE (SIZE (1..maxSCSs)) |
| OF SCS-SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL- |
| ConfigDedicated-IAB-MT-r16 | OPTIONAL, -- Cond |

TDD_IAB

| | |
|---|---|
| dormantBWP-Config-r16 | SetupRelease { |
| DormantBWP-Config-r16 } | OPTIONAL, -- |

Need M

| | |
|---|---|
| ca-SlotOffset-r16 | CHOICE { |
| refSCS15kHz | INTEGER (− |

2..2),

| | |
|---|---|
| refSCS30KHz | INTEGER (− |

5..5),

| | |
|---|---|
| refSCS60KHz | INTEGER (− |

10..10),

| | |
|---|---|
| refSCS120KHz | INTEGER (− |

20..20)
}
OPTIONAL, -- Cond AsyncCA

| | |
|---|---|
| channelAccessConfig-r16 | SetupRelease { |
| ChannelAccessConfig-r16 } | OPTIONAL, -- |

Need M

| | |
|---|---|
| intraCellGuardBandsDL-List-r16 | SEQUENCE (SIZE |

(1..maxSCSs)) OF IntraCellGuardBandsPerSCS-r16
OPTIONAL, -- Need S

| | |
|---|---|
| intraCellGuardBandsUL-List-r16 | SEQUENCE (SIZE |

(1..maxSCSs)) OF IntraCellGuardBandsPerSCS-r16
OPTIONAL, -- Need S

| | |
|---|---|
| csi-RS-Validation With-DCI-r16 | ENUMERATED {enabled} |

OPTIONAL, -- Need R

| | |
|---|---|
| lte-CRS-PatternList1-r16 | SetupRelease { LTE- |
| CRS-PatternList-r16 } | OPTIONAL, -- Need M |
| lte-CRS-PatternList2-r16 | SetupRelease { LTE- |
| CRS-PatternList-r16 } | OPTIONAL, -- Need M |
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED |
| {enabled} | OPTIONAL, |

-- Need R

| | |
|---|---|
| enableDefaultTCI-StatePerCoresetPoolIndex-r16 | ENUMERATED |
| {enabled} | OPTIONAL, -- Need R |
| enableBeamSwitchTiming-r16 | ENUMERATED |
| {true} | OPTIONAL, |

-- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

```
TABLE 23
    - RateMatchPatternLTE-CRS
The IE RateMatchPatternLTE-CRS is used to configure a pattern to rate match around LTE
CRS. See TS 38.214 [19], clause 5.1.4.2.
      RateMatchPatternLTE-CRS information element
-- ASN1START
-- TAG-RATEMATCHPATTERNLTE-CRS-START
```

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, |

n25, n50, n75, n100, spare2, spare1},

| | |
|---|---|
| mbsfn-SubframeConfigList | EUTRA-MBSFN- |
| SubframeConfigList | OPTIONAL, - |

- Need M

| | |
|---|---|
| nrofCRS-Ports | ENUMERATED {n1, n2, |

n4},

| | |
|---|---|
| v-Shift | ENUMERATED |

{n0, n1, n2, n3, n4, n5}
}

| | |
|---|---|
| LTE-CRS-PatternList-r16 ::= | SEQUENCE (SIZE (1..maxLTE-CRS- |

Patterns-r16)) OF RateMatchPatternLTE-CRS
-- TAG-RATEMATCHPATTERNLTE-CRS-STOP
-- ASN1STOP
RateMatch PatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19], clause
5.1.4.2).

### PDSCH: Processing Time

If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), DMRS-related information, time and frequency resource allocation information, and the like) indicated through DCI. The PUSCH preparation procedure time is defined in NR in consideration thereof. The PUSCH processing is expressed in Equation (2) below.

$${T}_{proc , 1} = ( {N}_{1} + {d}_{1 , 1} + {d}_{2} ) ( 2048 + 1 \; 44 ) {κ2}^{- μ} {T}_{c} + {T}_{ext} \qquad ( 2 )$$

In Equation (2), each parameter in T_{proc,1} may have the following meaning.

N₁: the number of symbols determined according to UE processing capability 1 or 2 based on the UE's capability and numerology u. N may have a value in Table 24 below concerning PDSCH processing time in PDSCH processing capability 1, if UE processing capability 1 is reported according to the UE's capability report, and may have a value in Table 25 below concerning PDSCH processing time in PDSCH processing capability 2, if UE processing capability 2 is reported, and if availability of UE processing capability 2 is configured through upper layer signaling. The numerology μ may correspond to the minimum value among μ_{PDCCH}, μ_{PDSCH}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an UL channel in which a HARQ-ACK is to be transmitted.

TABLE 24

| | PDSCH decoding time N₁ [symbols] | |
|---|---|---|
| | | If PDSCH mapping type A and |
| | If PDSCH mapping type A and | B both do not correspond to dmrs- |
| | B both correspond to dmrs- | AdditionalPosition = pos0 |
| | AdditionalPosition = pos0 | inside DMRS-DLConfig which is |
| | inside DMRS-DLConfig | upper layer signaling, |
| | which is upper | or if no upper layer |
| μ | layer signaling | parameter is configured |
| 0 | 8 | N_{1, 0} |
| 1 | 10 | 13 |
| 2 | 17 | 20 |
| 3 | 20 | 24 |

TABLE 25

| | PDSCH decoding time N₁ [symbols] |
|---|---|
| | If PDSCH mapping type A and B both correspond |
| | to dmrs-AdditionalPosition = pos0 inside |
| μ | DMRS-DLConfig which is upper layer signaling |
| 0 | 3 |
| 1 | 4.5 |
| 2 | 9 for frequency range 1 |

Further in Equation (2):
κ: 64

Tₑₓₜ: if the UE uses a shared spectrum channel access scheme, the UE may calculate Tₑₓₜ and apply the same to the PDSCH processing time. Otherwise, Tₑₓₜ may be assumed to be 0.

If l₁ which represents the PDSCH DMRS location value is 12, N_{1,0} in Table 22] above has the value of 14, and otherwise has the value of 13.

As to PDSCH mapping type A, if the last symbol of the PDSCH is the i^{th} symbol in the slot in which the PDSCH is transmitted, and if i<7, d_{1,1} is then 7-i, and d_{1,1} is otherwise 0.

d2: if a PUCCH having a high priority index temporally overlaps another PUCCH or a PUSCH having a low priority index, d2 of the PUCCH having a high priority index may be configured as a value reported from the UE. Otherwise, d2 is 0.

If PDSCH mapping type B is used as to UE processing capability 1, the d_{1,1} value may be determined by the number (L) of symbols of a scheduled PDSCH and the number of overlapping symbols between the PDCCH that schedules the PDSCH and the scheduled PDSCH, as follows.

If L≥7, then d1.1=0.

If −L≥4 and L≤6, then d_{1,1}=7−L.

If L=3, then d_{1,1}=min (d, 1).

If L=2, then d_{1,1}=3+d.

If PDSCH mapping type B is used as to UE processing capability 2, the d_{1,1} value may be determined by the number (L) of symbols of a scheduled PDSCH and the number of overlapping symbols between the PDCCH that schedules the PDSCH and the scheduled

PDSCH, as follows.

If L≥7, then d1.1=0.

If −L≥4 and L≤6, then d_{1,1}=7−L.

If L=2,

If the scheduling PDCCH exists inside a CORESET including three symbols, and if the CORESET and the scheduled PDSCH have the same start symbol, then d_{1,1}=3.

Otherwise, d_{1,1}=d.

In a UE supporting capability 2 inside a given serving cell, the PDSCH processing time based on UE processing capability 2 may be applied by the UE if processingType2Enabled (upper layer signaling) is configured as “enable” as to the corresponding cell.

If the location of the first UL transmission symbol of a PUCCH including HARQ-ACK information (in connection with the corresponding location, K₁ defined as the HARQ-ACK transmission timepoint, a PUCCH resource used to transmit the HARQ-ACK, and the timing advance effect may be considered) does not start earlier than the first UL transmission symbol that comes after the last symbol of the PDSCH over a time of T_{proc,1}, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in either a normal or an expanded CP. In a PDSCH having two PDSCH transmission locations configured inside one slot, d_{1,1} is calculated with reference to the first PDSCH transmission location inside the corresponding slot.

### Pdsch: Reception Preparation Time During Cross-Carrier Scheduling

In cross-carrier scheduling in which the numerology (μPDCCH) by which a scheduling PDCCH is transmitted and the numerology (μPDSCH) by which a PDSCH scheduled by the corresponding PDCCH is transmitted are different from each other, the PDSCH reception reparation time (N-pdsch) of the UE defined as to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 25-1
N_{pdsch} according to scheduled PDCCH subcarrier spacing

| μ_{PDCCH} | N_{pdsch} [symbols] |
|---|---|
| 0 | 4 |
| 1 | 5 |
| 2 | 10 |
| 3 | 14 |

### Sounding Reference Signal (SRS)

The base station may configure at least one SRS configuration as to each UL BWP to transfer configuration information for SRS transmission to the UE, and may also configure as least one SRS resource set as to each SRS configuration. As an example, the base station and the UE may exchange upper signaling information to transfer information regarding the SRS resource set.

srs-ResourceSetId: an SRS resource set index

srs-ResourceIdList: a set of SRS resource indices referred to by SRS resource sets

resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.

usage: a configuration regarding the place of use of SRS resources referred to by SRS resource sets, and may be configured as one of “beamManagement”, “codebook”, “nonCodebook”, and “antennaSwitching”.

alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

The base station and the UE may transmit/receive upper layer signaling information to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (e.g., periodicity AndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resource Type configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource. Slot mapping, including the transmission cycle and slot offset, follows periodicity AndOffset configured for the SRS resource. The spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the UL BWP activated as to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource may follow resource mapping information configured for the SRS resource. Slot mapping, including the transmission cycle and slot offset, follows periodicity AndOffset configured for the SRS resource. The spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the UL BWP activated as to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. Slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. The spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the UL BWP activated as to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. If the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is greater than or equal to the minimum time interval, and may ignore the DCI that triggers the aperiodic SRS if the time interval for aperiodic SRS transmission is less than the minimum time interval.

TABLE 26

| | |
|---|---|
| SRS-Resource ::= | SEQUENCE { |
| srs-ResourceId | , |
| nrofSRS-Ports | ENUMERATED {port1, |

ports2, ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, |
| | n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { |

neither, groupHopping, quenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS- |

```
PeriodicityAndOffset,
      ...
    },
```

| | |
|---|---|
| periodic | SEQUENCE { |
| periodicityAndOffset-p | SRS- |

```
PeriodicityAndOffset,
      ...
    }
  },
```

| | |
|---|---|
| sequenceId | INTEGER (0..1023), |
| spatialRelationInfo | SRS-SpatialRelationInfo |

```
  OPTIONAL, -- Need R
    ...
}
```

Configuration information spatialRelationInfo in Table 26 above may be applied, with reference to one reference signal, to a beam used for SRS transmission corresponding to beam information of the corresponding reference signal. For example, configuration of spatialRelationInfo may include information as in Table 27 below.

TABLE 27

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | |
| SSB-Index, | |
| csi-RS-Index | NZP- |

```
CSI-RS-ResourceId,
      srs
SEQUENCE {
          resourceId
SRS-ResourceId,
        ULBWP
BWP-Id
    }
  }
}
```

Referring to the spatialRelationInfo configuration, an SS/PBCH block index, CSI-RS index, or SRS index may be configured as the index of a reference signal to be referred to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “csi-RS-Index”, the UE may apply the reception beam which was used to receive the CSI-RS corresponding to csi-RS-Index as the transmission beam for the corresponding SRS transmission. If upper signaling referenceSignal has a configured value of “‘srs”, the UE may apply the reception beam which was used to transmit the SRS corresponding to srs as the transmission beam for the corresponding SRS transmission.

### Pusch as to Transmission Scheme

PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 28 below through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 28 through upper signaling. If PUSCH transmission is operated by a configured grant, parameters applied to the PUSCH transmission are applied through configuredGrantConfig (upper signaling) in Table 28 except for dataScramblingIdentityPUSCH, txConfig, codebookSubset, maxRank, and scaling of UCI-OnPUSCH, which are provided by pusch-Config (upper signaling) in Table 29 below. If provided with transformPrecoder inside configuredGrantConfig (upper signaling) in Table 28, the UE applies tp-pi2BPSK inside pusch-Config in Table 29 to PUSCH transmission operated by a configured grant.

TABLE 28

| | |
|---|---|
| ConfiguredGrantConfig ::= | SEQUENCE { |
| frequencyHopping | ENUMERATED {intraSlot, |

interSlot}
OPTIONAL, -- Need S,

| | |
|---|---|
| cg-DMRS-Configuration | DMRS-UplinkConfig, |
| mcs-Table | ENUMERATED {qam256, |
| qam64LowSE} | OPTIONAL, -- |

Need S

| | |
|---|---|
| mcs-TableTransformPrecoder | ENUMERATED {qam256, |
| qam64LowSE} | OPTIONAL, -- |

Need S

| | |
|---|---|
| uci-OnPUSCH | SetupRelease { CG- |
| UCI-OnPUSCH } | OPTIONAL, - |

- Need M

| | |
|---|---|
| resourceAllocation | ENUMERATED |

{ resourceAllocationType0, resourceAllocationType1, dynamicSwitch },

| | |
|---|---|
| rbg-Size | ENUMERATED |

{config2}
OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED |
| {enabled, disabled} | OPTIONAL, |

-- Need S

| | |
|---|---|
| nrofHARQ-Processes | INTEGER(1..16), |

repK
ENUMERATED {n1, n2, n4, n8},

| | |
|---|---|
| repK-RV | ENUMERATED |
| {s1-0231, s2-0303, s3-0000} | OPTIONAL, |

-- Need R

| | |
|---|---|
| periodicity | ENUMERATED { |
| | sym2, |

sym7, sym1x14, sym2x14, sym4x14, sym5x14, sym8x14, sym10x14, sym16x14,
sym20x14,
sym32x14, sym40x14, sym64x14, sym80x14, sym128x14, sym160x14, sym256x14,
sym320x14, sym512x14,
sym640x14, sym1024x14, sym1280x14, sym2560x14, sym5120x14,

sym6,

sym1x12, sym2x12, sym4x12, sym5x12, sym8x12, sym10x12, sym16x12, sym20x12,
sym32x12,
sym40x12, sym64x12, sym80x12, sym128x12, sym160x12, sym256x12, sym320x12,
sym512x12, sym640x12,
sym1280x12, sym2560x12
},

| | |
|---|---|
| configuredGrantTimer | INTEGER |

(1..64)
OPTIONAL, -- Need R

| | |
|---|---|
| rrc-ConfiguredUplinkGrant | SEQUENCE { |
| timeDomainOffset | INTEGER |

(0..5119),

| | |
|---|---|
| timeDomainAllocation | INTEGER |

(0..15),

| | |
|---|---|
| frequencyDomainAllocation | BIT STRING |

(SIZE(18)),
antennaPort
INTEGER (0..31),

| | |
|---|---|
| dmrs-SeqInitialization | INTEGER |

(0..1)
OPTIONAL, -- Need R

| | |
|---|---|
| precodingAndNumberOfLayers | INTEGER |

(0..63),

| | |
|---|---|
| srs-ResourceIndicator | INTEGER |

```
(0..15)
OPTIONAL, -- Need R
    mcsAndTBS
INTEGER (0..31),
    frequencyHoppingOffset
INTEGER (1.. maxNrofPhysicalResourceBlocks-1)
OPTIONAL, -- Need R
    pathlossReferenceIndex
INTEGER (0..maxNrofPUSCH-PathlossReferenceRSs-1),
    ...
  }
OPTIONAL, -- Need R
  ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 29 below, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated UL BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 29, the UE does not expect scheduling through DCI format 0_1.

TABLE 29

| | |
|---|---|
| PUSCH-Config ::= | SEQUENCE { |
| dataScramblingIdentityPUSCH | INTEGER (0..1023) |

OPTIONAL, -- Need S
txConfig
ENUMERATED {codebook, nonCodebook}
OPTIONAL, -- Need S

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |

pusch-PowerControl
OPTIONAL, -- Need M

| | |
|---|---|
| frequencyHopping | ENUMERATED |
| {intraSlot, interSlot} | OPTIONAL, -- |

Need S

| | |
|---|---|
| frequencyHoppingOffsetLists | SEQUENCE (SIZE (1..4)) OF |

INTEGER (1.. maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED |
| {qam256, qam64LowSE} | OPTIONAL, |

-- Need S

| | |
|---|---|
| mcs-TableTransformPrecoder | ENUMERATED {qam256, |
| qam64LowSE} | OPTIONAL, -- Need |

S

| | |
|---|---|
| transformPrecoder | ENUMERATED |
| {enabled, disabled} | OPTIONAL, -- |

Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER |

(1..4)
OPTIONAL, -- Cond codebookBased
rbg-Size
ENUMERATED { config2}
OPTIONAL, -- Need S

| | |
|---|---|
| uci-OnPUSCH | SetupRelease |
| { UCI-OnPUSCH} | OPTIONAL, -- Need |

M

| | |
|---|---|
| tp-pi2BPSK | ENUMERATED |
| {enabled} | OPTIONAL, -- |

Need S
...
}

The codebook-based PUSCH transmission may be dynamically scheduled through DCI format 0_0 or 0_1, and may be semi-statically operated by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI may refer to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI may be used to indicate a precoder to be applied in an SRS resource indicated through the SRI.

The precoder to be used for PUSCH transmission may be selected from a UL codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fully AndPartial AndNonCoherent”, “partial AndNonCoherent”, or “noncoherent”, based on UE capability reported by the UE to the base station. If the UE reported “partialAndNonCoherent” as UE capability, the UE may not expect that the value of codebookSubset (upper signaling) will be configured as “fully AndPartialAndNonCoherent”. If the UE reported “nonCoherent” as UE capability, UE may not expect that the value of codebook Subset (upper signaling) will be configured as “fully AndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partial AndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

The non-codebook-based PUSCH transmission may be dynamically scheduled through DCI format 0_0 or 0_1, and may be semi-statically operated by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

As to the SRS resource set wherein the value of usage inside SRS-ResourceSet (upper signaling) is “nonCodebook”, one connected NZP CSI-RS resource (non-ZP (NZP) CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated as to the case in which the value of SRS request (a field inside DCI format 0_1 or 1_1) is not “00”. The corresponding DCI should not indicate cross carrier or cross BWP scheduling. If the value of SRS request indicates the existence of a NZP CSI-RS, the NZP CSI-RS may be located in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associated CSI-RS inside SRS-ResourceSet (upper signaling). As to non-codebook-based transmission, the UE may not expect that spatialRelationInfo which is upper signaling regarding the SRS resource and associated CSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### Pusch: Preparation Procedure Time

If a base station schedules a UE to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation (3) below.

$${T}_{proc , 2} = max ( ( {N}_{2} + {d}_{2 , 1} + {d}_{2} ) ( 2048 + 1 \; 44 ) {κ2}^{- μ} {T}_{c} + {T}_{ext} + {T}_{switch} , {d}_{2 , 2} ) \qquad ( 3 )$$

in Equation (3), each parameter in T_{proc,2} may have the following meaning.

N₂: the number of symbols determined according to UE processing capability 1 or 2, based on the UE's capability, and numerology μ. N₂ may have a value in Table 30 below if UE processing capability 1 is reported according to the UE's capability report, and may have a value in Table 31 below if UE processing capability 2 is reported, and if availability of UE processing capability 2 is configured through upper layer signaling.

TABLE 30

| μ | PUSCH preparation time N₂ [symbols] |
|---|---|
| 0 | 10 |
| 1 | 12 |
| 2 | 23 |
| 3 | 36 |

TABLE 31

| μ | PUSCH preparation time N₂ [symbols] |
|---|---|
| 0 | 5 |
| 1 | 5.5 |
| 2 | 11 for frequency range 1 |

Further in Equation (3):
d2,1: the number of symbols determined to be 0 if all REs of the first OFDM symbol of PUSCH transmission include DM-RSs, and to be 1 otherwise.
κ: 64

μ: follows a value, among μDL and μUL which increases the size of T_{proc,2}. μDL refers to the numerology of a DL used to transmit a PDCCH including DCI that schedules a PUSCH, and μUL refers to the numerology of a UL used to transmit a PUSCH.

$${T}_{c} : has 1 / ( Δ {f}_{max} \cdot {N}_{f} ) , Δ {f}_{max} = 480 \cdot {10}^{3} Hz , {N}_{f} = 4096 …$$

d_{2,2}: follows a BWP switching time if DCI that schedules a PUSCH indicates BWP switching, and has 0 otherwise.

d₂: if OFDM symbols overlap temporally between a PUSCH having a high priority index and a PUCCH having a low priority index, the d2 value of the PUSCH having a high priority index is used. Otherwise, d2 is 0.

Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.

T_{switch}: if a UL switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first UL symbol in which a CP starts after T_{proc,2} from the last symbol of a PDCCH including DCI that schedules the PUSCH, in view of the influence of timing advance between the UL and the DL and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### Pusch as to Repetition Transmission

A 5G system supports two types of UL data channel repetition transmission methods, PUSCH repetition type A transmission and PUSCH repetition type B transmission. One of PUSCH repetition type A transmission and PUSCH repetition type B transmission may be configured for a UE through upper layer signaling.

### Pusch Repetition Type a Transmission

As described above, the symbol length of a UL data channel and the location of the start symbol may be determined by a time domain resource allocation method in one slot, and a base station may notify a UE of the number of repetition transmissions through upper layer signaling (for example, RRC signaling) or L1 signaling (for example, DCI).

Based on the number of repetition transmissions received from the base station, the UE may repetitively transmit a UL data channel having the same length and start symbol as the configured UL data channel, in a continuous slot. If the base station configured a slot as a DL for the UE, or if at least one of symbols of the UL data channel configured for the UE is configured as a DL, the UE may omit UL data channel transmission, but may count the number of repeated transmissions of the UL data channel.

### Pusch Repetition Type B Transmission

As described above, the symbol length of a UL data channel and the location of the start symbol may be determined by a time domain resource allocation method in one slot, and a base station may notify a UE of the number of repetition transmissions through upper layer signaling (for example, RRC signaling) or L1 signaling (for example, DCI).

The nominal repetition of the UL data channel is determined as follows, based on the previously configured start symbol and length of the UL data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod(S+(n+1)·L−1, N_{symb}^{slot}). In this regard, n=0, . . . , numberofrepetitions−1, S refers to the start symbol of the configured UL data channel, and L refers to the symbol length of the configured UL data channel. Kₛ refers to the slot in which PUSCH transmission starts, and N_{symb}^{slot} refers to the number of symbols per slot.

The UE may determine an invalid symbol for PUSCH repeated transmission type B. A symbol configured as a DL by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 may represent the invalid symbol. The periodicity and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern.

After an invalid symbol is determined, the UE may consider, as to each nominal repetition, that symbols other than the invalid symbol are valid symbols. If one or more valid symbols are included in each nominal repetition, the nominal repetition may include one or more actual repetitions. Each actual repetition may include a set of consecutive valid symbols available for PUSCH repeated transmission type B in one slot.

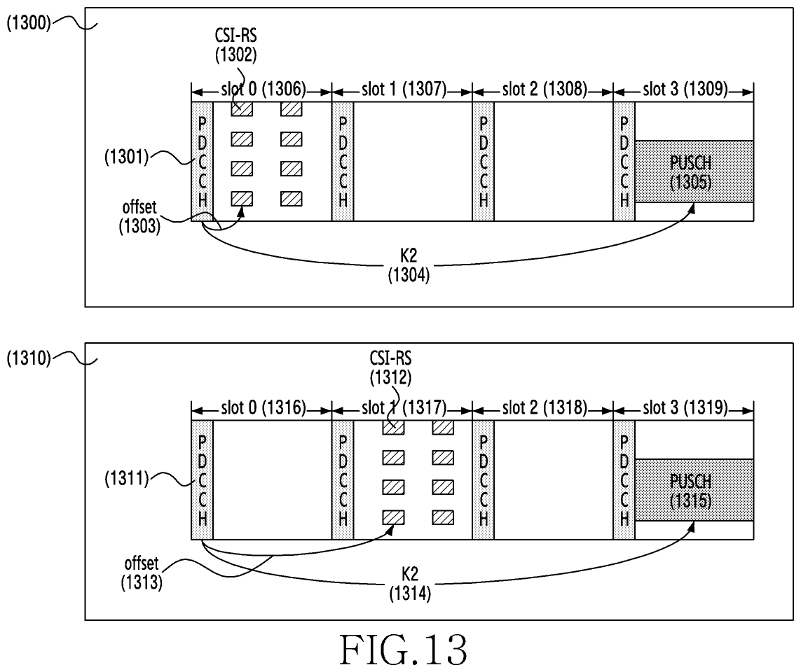

FIG. 13 illustrates examples of an aperiodic CSI report method according to an embodiment.

Referring to section 1300 of FIG. 13, a UE may acquire DCI format 0_1 by monitoring a PDCCH 1301, and may acquire scheduling information and CSI request information for a PUSCH 1305 therefrom. The UE may acquire resource information of a CSI-RS 1302 to be measured, from a received CSI request indicator. The UE may determine a time point at which the UE needs to measure a resource of the CSI-RS 1302, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 32 below.

TABLE 32

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

Section 1300 of FIG. 13 shows an example in which aforementioned offset value X is configured to be 0 (X=0). In this case, the UE may receive the CSI-RS 1302 in a slot (corresponding to slot 0 1306 of FIG. 13) in which DCI format 0_1 triggering aperiodic CSI reporting is received, and may report CSI information, which is measured based on the received CSI-RS, to the base station via the PUSCH 1305. The UE may acquire, from DCI format 0_1, scheduling information (information corresponding to each field of DCI format 0_1 described above) on the PUSCH 1305 for CSI reporting. For example, in DCI format 0_1, the UE may acquire information on a slot in which the PUSCH 1305 is to be transmitted, from time domain resource allocation information for the PUSCH 1305 described above. The UE acquires 3 as a K2 value corresponding to a slot offset value for PDCCH-to-PUSCH, and accordingly, the PUSCH 1305 may be transmitted in slot 3 1309, which is spaced 3 slots apart from slot 0 1306, i.e., a time point at which the PDCCH 1301 has been received.

Referring to section 1310 of FIG. 13, the UE may acquire DCI format 0_1 by monitoring a PDCCH 1311, and may acquire scheduling information and CSI request information for a PUSCH 1315 therefrom. The UE may acquire resource information of a CSI-RS 1312 to be measured, from a received CSI request indicator. The example 1310 of FIG. 13 shows an example in which the offset value X for CSI-RS described above is configured to be 1 (X=1). In this case, the UE may receive the CSI-RS 1312 in a slot (corresponding to slot 0 1316 of FIG. 13) in which DCI format 0_1 triggering aperiodic CSI reporting is received, and may report CSI information, which is measured based on the received CSI-RS, to the base station via the PUSCH 1315.

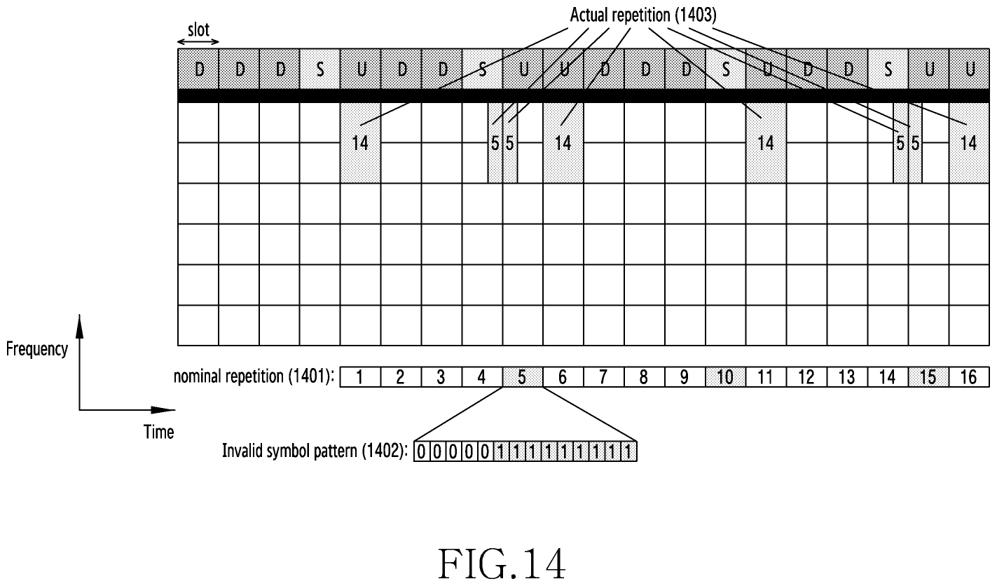

FIG. 14 illustrates an example of PUSCH repetition type B transmission in a wireless communication system according to an embodiment. Referring to FIG. 14, the UE may receive the following configurations: the start symbol S of a UL data channel is 0, the length L of the UL data channel is 14, and the number of repeated transmissions is 16. In this case, nominal repetitions 1401 may appear in 16 consecutive slots. Thereafter, the UE may determine that the symbol configured as a DL symbol in each nominal repetition 1401 is an invalid symbol. The UE may determine that symbols configured as 1 in the invalid symbol pattern 1402 are invalid symbols. If valid symbols other than invalid symbols in respective nominal repetitions constitute one or more consecutive symbols in one slot, they may be configured and transmitted as actual repetitions 1403.

In addition, as to PUSCH repeated transmission, additional methods may be defined in the relevant standard as to UL grant-based PUSCH transmission and configured grant-based PUSCH transmission, across slot boundaries, as follows:

Method 1 (mini-slot level repetition): through one UL grant, two or more PUSCH repetition transmissions are scheduled inside one slot or across the boundary of consecutive slots. In method 1, time domain resource allocation information inside DCI indicates resources of the first repetition transmission. Time domain resource information of remaining repetition transmissions may be determined according to time domain resource information of the first repetition transmission, and the UL or DL direction determined as to each symbol of each slot. Each repetition transmission occupies consecutive symbols.

Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In performing repetition transmissions inside a single slot through method 2, if there are multiple bundles of consecutive UL symbols in the corresponding slot, respective repetition transmissions may be performed as to respective UL symbol bundles. If there is a single bundle of consecutive UL symbols in the corresponding slot, PUSCH repetition transmission is performed once according to the relevant standard.

Method 3: two or more PUSCH repetition transmissions are scheduled in consecutive slots through two or more UL grants. Transmission no. 1 may be designated as to each slot, and the nth UL grant may be received before PUSCH transmission scheduled by the (n−1)th UL grant is over.

Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the UL or DL direction of symbols. If time domain resource information of repetition transmission indicated by the base station spans a slot boundary or includes a UL/DL switching point, the corresponding repetition transmission may be divided into multiple repeated transmissions. One repetition transmission may be included in one slot as to each UL period.

### PUSCH: Frequency Hopping Process

5G may support two types of PUSCH frequency hopping methods as to each PUSCH repeated transmission type. In PUSCH repeated transmission type A, intra-slot frequency hopping and inter-slot frequency hopping are supported, and in PUSCH repeated transmission type B, inter-repetition frequency hopping and inter-slot frequency hopping are supported. Obviously, the example given above is not limiting.

The intra-slot frequency hopping method supported in PUSCH repeated transmission type A may include a method in which a UE transmits allocated resources in the frequency domain, after changing the same by a configured frequency offset, by two hops in one slot. The start RB of each hop in connection with intra-slot frequency hopping may be expressed by Equation (4) below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( 4 )$$

In Equation (4), i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,S} is the length of PUSCH transmission in one slot and is expressed by the number of OFDM symbols.

Next, the inter-slot frequency hopping method supported in PUSCH repeated transmission types A and B is a method in which the UE transmits allocated resources in the frequency domain, after changing the same by a configured frequency offset, in each slot. The start RB during a slot in connection with inter-slot frequency hopping may be expressed by Equation (5) below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 5 )$$

In Equation (5), nₛ^{μ} denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

The inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may follow Equation (6) below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 6 )$$

In Equation (6), n denotes the index of nominal repetition, and RB_{offset} denotes an RB offset between two hops through an upper layer parameter.

### PUSCH: Multiplexing Rules During AP/SP CSI Reporting

CSI may include a channel quality indicator (CQI), a precoding matrix index (precoding matrix indicator (PMI)), a CSI-RS resource indicator (CRI), an SS/PBCH block resource indicator (SSBRI), a layer indicator (LI), a rank indicator (RI), a reference signal received power (L1-RSRP), and/or the like. A base station may control time and frequency resources for the aforementioned CSI measurement and report of a UE.

For the aforementioned CSI measurement and report, the UE may be configured, via higher-layer signaling, with setting information for N (N≥1) CSI reports (CSI-ReportConfig), setting information for M (M>1) RS transmission resources (CSI-ResourceConfig), and list information of one or two trigger states (CSI-AperiodicTriggerStateList, CSI-SemiPersistentOnPUSCH-TriggerStateList). The configuration information for CSI measurement and reporting described above may be, more specifically, as described in Table 33 to Table 39 below.

TABLE 33
The IE CSI-ReportConfig is used to configure a periodic or semi-persistent report
sent on PUCCH on the cell in which the CSI-ReportConfig is included, or to configure a
semi-persistent or aperiodic report sent on PUSCH triggered by DCI received on the cell in
which the CSI-ReportConfig is included (in this case, the cell on which the report is sent is
determined by the received DCI). See TS 38.214 [19], clause 5.2.1.
CSI-ReportConfig information element

```
  -- ASN1START
  -- TAG-CSI-REPORTCONFIG-START
```

| | |
|---|---|
| CSI-ReportConfig ::= | SEQUENCE { |

| | |
|---|---|
| reportConfigId | CSI-ReportConfigId, |

| | |
|---|---|
| carrier | ServCellIndex |

OPTIONAL, -- Need S

| | |
|---|---|
| resourcesForChannelMeasurement | CSI-ResourceConfigId, |

| | |
|---|---|
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |

| | |
|---|---|
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |

| | |
|---|---|
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |

| | |
|---|---|
| reportSlotConfig | ENUMERATED |

{sl5, sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |

| | |
|---|---|
| reportSlotOffsetList | SEQUENCE (SIZE |

```
(1..maxNrofUL-Allocations)) OF INTEGER(0..32)
      }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |

| | |
|---|---|
| pdsch-BundleSizeForCSI | ENUMERATED |

| | |
|---|---|
| {n2, n4} | OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |

| | |
|---|---|
| cqi-FormatIndicator | ENUMERATED { |

| | |
|---|---|
| widebandCQI, subbandCQI } | OPTIONAL, -- Need R |

| | |
|---|---|
| pmi-FormatIndicator | ENUMERATED { |

| | |
|---|---|
| widebandPMI, subbandPMI } | OPTIONAL, -- Need R |
| csi-ReportingBand | CHOICE { |

| | |
|---|---|
| subbands3 | BIT |

STRING(SIZE(3)),

| | |
|---|---|
| subbands4 | BIT |

STRING(SIZE(4)),

| | |
|---|---|
| subbands5 | BIT |

STRING(SIZE(5)),

| | |
|---|---|
| subbands6 | BIT |

STRING(SIZE(6)),

| | |
|---|---|
| subbands7 | BIT |

STRING(SIZE(7)),

| | |
|---|---|
| subbands8 | BIT |

STRING(SIZE(8)),

| | |
|---|---|
| subbands9 | BIT |

STRING(SIZE(9)),

| | |
|---|---|
| subbands10 | BIT |

STRING(SIZE(10)),

| | |
|---|---|
| subbands11 | BIT |

STRING(SIZE(11)),

| | |
|---|---|
| subbands12 | BIT |

STRING(SIZE(12)),

| | |
|---|---|
| subbands13 | BIT |

STRING(SIZE(13)),

| | |
|---|---|
| subbands14 | BIT |

STRING(SIZE(14)),

| | |
|---|---|
| subbands15 | BIT |

STRING(SIZE(15)),

| | |
|---|---|
| subbands16 | BIT |

STRING(SIZE(16)),

| | |
|---|---|
| subbands17 | BIT |

STRING(SIZE(17)),

| | |
|---|---|
| subbands18 | BIT |

STRING(SIZE(18)),

| ..., | |
|---|---|
| subbands19-v1530 | BIT |

STRING(SIZE(19))

| | |
|---|---|
| } | OPTIONAL -- Need S |

}
OPTIONAL, -- Need R

| | |
|---|---|
| timeRestrictionForChannelMeasurements | ENUMERATED |

{configured, notConfigured},

| | |
|---|---|
| timeRestrictionForInterferenceMeasurements | ENUMERATED |

{configured, notConfigured},

| | |
|---|---|
| codebookConfig | CodebookConfig |

OPTIONAL, -- Need R

| | |
|---|---|
| dummy | ENUMERATED |

| | |
|---|---|
| {n1, n2} | OPTIONAL, -- Need R |
| groupBasedBeamReporting | CHOICE { |

| enabled | | NULL, |
|---|---|---|
| disabled | | SEQUENCE { |
| | nrofReportedRS | ENUMERATED |

| | |
|---|---|
| {n1, n2, n3, n4} | OPTIONAL -- Need S |

```
      }
    },
```

| | |
|---|---|
| cqi-Table | ENUMERATED {table1, table2, table3, |
| spare1} | OPTIONAL, -- Need R |
| subbandSize | ENUMERATED {value1, value2}, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
    ...,
    [[
```

| | |
|---|---|
| semiPersistentOnPUSCH-v1530 | SEQUENCE { |
| reportSlotConfig-v1530 | ENUMERATED {sl4, sl8, sl16} |

```
    }
OPTIONAL -- Need R
    ]],
    [[
```

| | |
|---|---|
| semiPersistentOnPUSCH-v1610 | SEQUENCE { |
| reportSlotOffsetListDCI-0-2-r16 | SEQUENCE (SIZE (1.. |
| maxNrofUL-Allocations-r16)) OF INTEGER(0..32) | OPTIONAL, -- Need R |
| reportSlotOffsetListDCI-0-1-r16 | SEQUENCE (SIZE (1.. |
| maxNrofUL-Allocations-r16)) OF INTEGER(0..32) | OPTIONAL -- Need R |

}
OPTIONAL, -- Need R

| | |
|---|---|
| aperiodic-v1610 | SEQUENCE { |
| reportSlotOffsetListDCI-0-2-r16 | SEQUENCE (SIZE (1.. |
| maxNrofUL-Allocations-r16)) OF INTEGER(0..32) | OPTIONAL, -- Need R |
| reportSlotOffsetListDCI-0-1-r16 | SEQUENCE (SIZE (1.. |
| maxNrofUL-Allocations-r16)) OF INTEGER(0..32) | OPTIONAL -- Need R |

}
OPTIONAL, -- Need R

| | |
|---|---|
| reportQuantity-r16 | CHOICE { |

| | |
|---|---|
| cri-SINR-r16 | NULL, |
| ssb-Index-SINR-r16 | NULL |

}
OPTIONAL, -- Need R

| | |
|---|---|
| codebookConfig-r16 | CodebookConfig-r16 |

```
OPTIONAL -- Need R
    ]]
  }
```

| | |
|---|---|
| CSI-ReportPeriodicityAndOffset ::= | CHOICE { |

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |

| | |
|---|---|
| pucch-Resource | PUCCH-ResourceId |

}

| | |
|---|---|
| PortIndexFor8Ranks ::= | CHOICE { |

| | |
|---|---|
| portIndex8 | SEQUENCE{ |

| | |
|---|---|
| rank1-8 | PortIndex8 |

OPTIONAL, -- Need R

| | |
|---|---|
| rank2-8 | SEQUENCE(SIZE(2)) OF |

| | |
|---|---|
| PortIndex8 | OPTIONAL, -- Need R |

| | |
|---|---|
| rank3-8 | SEQUENCE(SIZE(3)) OF |

| | |
|---|---|
| PortIndex8 | OPTIONAL, -- Need R |

| | |
|---|---|
| rank4-8 | SEQUENCE(SIZE(4)) OF |

| | |
|---|---|
| PortIndex8 | OPTIONAL, -- Need R |

| | |
|---|---|
| rank5-8 | SEQUENCE(SIZE(5)) OF |

| | |
|---|---|
| PortIndex8 | OPTIONAL, -- Need R |

| | |
|---|---|
| rank6-8 | SEQUENCE(SIZE(6)) OF |

| | |
|---|---|
| PortIndex8 | OPTIONAL, -- Need R |

| | |
|---|---|
| rank7-8 | SEQUENCE(SIZE(7)) OF |

| | |
|---|---|
| PortIndex8 | OPTIONAL, -- Need R |

| | |
|---|---|
| rank8-8 | SEQUENCE(SIZE(8)) OF |

| | |
|---|---|
| PortIndex8 | OPTIONAL -- Need R |

},

| | |
|---|---|
| portIndex4 | SEQUENCE{ |

| | |
|---|---|
| rank1-4 | PortIndex4 |

OPTIONAL, -- Need R

| | |
|---|---|
| rank2-4 | SEQUENCE(SIZE(2)) OF |

| | |
|---|---|
| PortIndex4 | OPTIONAL, -- Need R |

| | |
|---|---|
| rank3-4 | SEQUENCE(SIZE(3)) OF |

| | |
|---|---|
| PortIndex4 | OPTIONAL, -- Need R |

| | |
|---|---|
| rank4-4 | SEQUENCE(SIZE(4)) OF |

| | |
|---|---|
| PortIndex4 | OPTIONAL -- Need R |

},

| | |
|---|---|
| portIndex2 | SEQUENCE{ |

| | |
|---|---|
| rank1-2 | PortIndex2 |

OPTIONAL, -- Need R

| | |
|---|---|
| rank2-2 | SEQUENCE(SIZE(2)) OF |

| | |
|---|---|
| PortIndex2 | OPTIONAL -- Need R |

},

| | |
|---|---|
| portIndex1 | NULL |

}

| | |
|---|---|
| PortIndex8::- | INTEGER (0..7) |
| PortIndex4::= | INTEGER (0..3) |
| PortIndex2::= | INTEGER (0..1) |

```
  -- TAG-CSI-REPORTCONFIG-STOP
  -- ASN1STOP
```

CSI-ReportConfig field descriptions
carrier
Indicates in which serving cell the CSI-ResourceConfig indicated below are to be
found. If the field is absent, the resources are on the same serving cell as this report
configuration.
codebookConfig
Codebook configuration for Type-1 or Type-2 including codebook subset
restriction. Network does not configure codebookConfig and codebookConfig-r16
simultaneously to a UE
cqi-FormatIndicator
Indicates whether the UE shall report a single (wideband) or multiple (subband)
CQI. (see TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the field
“carrier” above. The CSI-ResourceConfig indicated here contains only CSI-IM resources.
The bwp-Id in that CSI-ResourceConfig is the same value as the bwp-Id in the CSI-
ResourceConfig indicated by resourcesForChannelMeasurement.
csi-ReportingBand
Indicates a contiguous or non-contiguous subset of subbands in the BWP which
CSI shall be reported for. Each bit in the bit-string represents one subband. The right-most
bit in the bit string represents the lowest subband in the BWP. The choice determines the
number of subbands (subbands3 for 3 subbands, subbands4 for 4 subbands, and so on)
(see TS 38.214 [19], clause 5.2.1.4). This field is absent if there are less than 24 PRBs (no
sub band) and present otherwise, the number of sub bands can be from 3 (24 PRBs, sub
band size 8) to 18 (72 PRBs, sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked
ResourceConfig for channel measurement, a port indication for each rank R, indicating
which R ports to use. Applicable only for non-PMI feedback (see TS 38.214 [19], clause
5.2.1.4.2).
The first entry in non-PMI-PortIndication corresponds to the NZP-CSI-RS-
Resource indicated by the first entry in nzp-CSI-RS-Resources in the NZP-CSI-RS-
ResourceSet indicated in the first entry of nzp-CSI-RS-ResourceSetList of the CSI-
ResourceConfig whose CSI-ResourceConfigId is indicated in a CSI-MeasId together with
the above CSI-ReportConfigId; the second entry in non-PMI-PortIndication corresponds
to the NZP-CSI-RS-Resource indicated by the second entry in nzp-CSI-RS-Resources in
the NZP-CSI-RS-ResourceSet indicated in the first entry of nzp-CSI-RS-ResourceSetList
of the same CSI-ResourceConfig, and so on until the NZP-CSI-RS-Resource indicated by
the last entry in nzp-CSI-RS-Resources in the in the NZP-CSI-RS-ResourceSet indicated
in the first entry of nzp-CSI-RS-ResourceSetList of the same CSI-ResourceConfig. Then
the next entry corresponds to the NZP-CSI-RS-Resource indicated by the first entry in
nzp-CSI-RS-Resources in the NZP-CSI-RS-ResourceSet indicated in the second entry of
nzp-CSI-RS-ResourceSetList of the same CSI-ResourceConfig and so on.
nrofReportedRS
The number (N) of measured RS resources to be reported per report setting in a
non-group-based report. N <= N_max, where N_max is either 2 or 4 depending on UE
capability.
(see TS 38.214 [19], clause 5.2.1.4) When the field is absent the UE applies the
value 1.
nzp-CSI-RS-ResourcesForInterference
NZP CSI RS resources for interference measurement. csi-ResourceConfigId of a
CSI-ResourceConfig included in the configuration of the serving cell indicated with the
field “carrier” above. The CSI-ResourceConfig indicated here contains only NZP-CSI-RS
resources. The bwp-Id in that CSI-ResourceConfig is the same value as the bwp-Id in the
CSI-ResourceConfig indicated by resourcesForChannelMeasurement.
p0alpha
Index of the p0-alpha set determining the power control for this CSI report
transmission (see TS 38.214 [19], clause 6.2.1.2).
pdsch-BundleSizeForCSI
PRB bundling size to assume for CQI calculation when reportQuantity is
CRI/RI/i1/CQI. If the field is absent, the UE assumes that no PRB bundling is applied (see
TS 38.214 [19], clause 5.2.1.4.2).
pmi-FormatIndicator
Indicates whether the UE shall report a single (wideband) or multiple (subband)
PMI. (see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause
5.2.1.4).
reportQuantity
The CSI related quantities to report. see TS 38.214 [19], clause 5.2.1. If the field
reportQuantity-r16 is present, UE shall ignore reportQuantity (without suffix).
reportSlotConfig
Periodicity and slot offset (see TS 38.214 [19], clause 5.2.1.4). If the field
reportSlotConfig-v1530 is present, the UE shall ignore the value provided in
reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the
allowed offset values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in
this list, the DCI value 1 corresponds to the second report slot offset in this list, and so on.
The first report is transmitted in slot n + Y, second report in n + Y + P, where P is the
configured periodicity.
Timing offset Y for aperiodic reporting using PUSCH. This field lists the allowed
offset values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in
this list, the DCI value 1 corresponds to the second report slot offset in this list, and so on
(see TS 38.214 [19], clause 6.1.2.1). The field reportSlotOffsetList applies to DCI format
0_0, the field reportSlotOffsetListDCI-0-1 applies to DCI format 0_1 and the field
reportSlotOffsetListDCI-0-2 applies to DCI format 0_2 (see TS 38.214 [19], clause
6.1.2.1).
resourcesForChannelMeasurement
Resources for channel measurement. csi-ResourceConfigId of a CSI-
ResourceConfig included in the configuration of the serving cell indicated with the field
“carrier” above. The CSI-ResourceConfig indicated here contains only NZP-CSI-RS
resources and/or SSB resources. This CSI-ReportConfig is associated with the DL BWP
indicated by bwp-Id in that CSI-ResourceConfig.
subbandSize
Indicates one out of two possible BWP-dependent values for the subband size as
indicated in TS 38.214 [19], table 5.2.1.4-2. If csi-ReportingBand is absent, the UE shall
ignore this field.
timeRestrictionForChannelMeasurements
Time domain measurement restriction for the channel (signal) measurements (see
TS 38.214 [19], clause 5.2.1.1).
timeRestrictionForInterferenceMeasurements
Time domain measurement restriction for interference measurements (see TS
38.214 [19], clause 5.2.1.1).

TABLE 34
The IE CSI-ResourceConfig defines a group of one or more NZP-CSI-RS-
ResourceSet, CSI-IM-ResourceSet and/or CSI-SSB-ResourceSet.
CSI-ResourceConfig information element

```
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResourceSetList | CHOICE { |

| | |
|---|---|
| nzp-CSI-RS-SSB | SEQUENCE { |

| | |
|---|---|
| nzp-CSI-RS-ResourceSetList | SEQUENCE (SIZE |

(1..maxNrofNZP-CSI-RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI- |

| | |
|---|---|
| SSB-ResourceSetsPerConfig)) OF CSI-SSB-ResourceSetId | OPTIONAL -- Need R |

},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, |

```
periodic },
    ...
  }
  -- TAG-CSI-RESOURCECONFIG-STOP
  -- ASN1STOP
```

CSI-ResourceConfig field descriptions
bwp-Id
The DL BWP which the CSI-RS associated with this CSI-ResourceConfig are
located in (see TS 38.214 [19], clause 5.2.1.2.
csi-IM-ResourceSetList
List of references to CSI-IM resources used for beam measurement and reporting
in a CSI-RS resource set. Contains up to maxNrofCSI-IM-ResourceSetsPerConfig
resource sets if resourceType is “aperiodic” and 1 otherwise (see TS 38.214 [19], clause
5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in
a CSI-RS resource set (see TS 38.214 [19], clause 5.2.1.2).
nzp-CSI-RS-ResourceSetList
List of references to NZP CSI-RS resources used for beam measurement and
reporting in a CSI-RS resource set. Contains up to maxNrofNZP-CSI-RS-
ResourceSetsPerConfig resource sets if resourceType is “aperiodic” and 1 otherwise (see
TS 38.214 [19], clause 5.2.1.2).
resourceType
Time domain behavior of resource configuration (see TS 38.214 [19], clause
5.2.1.2). It does not apply to resources provided in the csi-SSB-ResourceSetList.

TABLE 35
The IE NZP-CSI-RS-ResourceSet is a set of Non-Zero-Power
(NZP) CSI-RS resources (their IDs) and set-specific parameters.
NZP-CSI-RS-ResourceSet information element

```
  -- ASN1START
  -- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
    ...,
    [[
```

| | |
|---|---|
| aperiodicTriggeringOffset-r16 | INTEGER(0..31) |

```
OPTIONAL -- Need S
    ]]
  }
  -- TAG-NZP-CSI-RS-RESOURCESET-STOP
  -- ASN1STOP
```

NZP-CSI-RS-ResourceSet field descriptions
aperiodicTriggeringOffset, aperiodicTriggeringOffset-r16
Offset X between the slot containing the DCI that triggers a set of aperiodic NZP
CSI-RS resources and the slot in which the CSI-RS resource set is transmitted. For
aperiodicTriggeringOffset, the value 0 corresponds to 0 slots, value 1 corresponds to 1
slot, value 2 corresponds to 2 slots, value 3 corresponds to 3 slots, value 4 corresponds to
4 slots, value 5 corresponds to 16 slots, value 6 corresponds to 24 slots. For
aperiodicTriggeringOffset-r16, the value indicates the number of slots. The network
configures only one of the fields. When neither field is included, the UE applies the value
0.
nzp-CSI-RS-Resources
NZP-CSI-RS-Resources associated with this NZP-CSI-RS resource set (see TS
38.214 [19], clause 5.2). For CSI, there are at most 8 NZP CSI RS resources per resource
set.
repetition
Indicates whether repetition is on/off. If the field is set to off or if the field is absent,
the UE may not assume that the NZP-CSI-RS resources within the resource set are
transmitted with the same DL spatial domain transmission filter (see TS 38.214 [19],
clauses 5.2.2.3.1 and 5.1.6.1.2). It can only be configured for CSI-RS resource sets which
are associated with CSI-ReportConfig with report of L1 RSRP or “no report”.
trs-Info
Indicates that the antenna port for all NZP-CSI-RS resources in the CSI-RS
resource set is same. If the field is absent or released the UE applies the value false (see
TS 38.214 [19], clause 5.2.2.3.1).

TABLE 36
The IE CSI-SSB-ResourceSet is used to configure one
SS/PBCH block resource set which refers to SS/PBCH
as indicated in ServingCellConfigCommon.
CSI-SSB-ResourceSet information element

```
  -- ASN1START
  -- TAG-CSI-SSB-RESOURCESET-START
```

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI- |

```
SSB-ResourcePerSet)) OF SSB-Index,
    ...
  }
  -- TAG-CSI-SSB-RESOURCESET-STOP
  -- ASN1STOP
```

TABLE 37
The IE CSI-IM-ResourceSet is used to configure a set of one or more CSI
Interference Management (IM) resources (their IDs) and set-specific parameters.
CSI-IM-ResourceSet information element

```
  -- ASN1START
  -- TAG-CSI-IM-RESOURCESET-START
```

| | |
|---|---|
| CSI-IM-ResourceSet ::= | SEQUENCE { |
| csi-IM-ResourceSetId | CSI-IM-ResourceSetId, |
| csi-IM-Resources | SEQUENCE |

```
(SIZE(1..maxNrofCSI-IM-ResourcesPerSet)) OF CSI-IM-ResourceId,
    ...
  }
  -- TAG-CSI-IM-RESOURCESET-STOP
  -- ASN1STOP
```

CSI-IM-ResourceSet field descriptions
csi-IM-Resources
CSI-IM-Resources associated with this CSI-IM-ResourceSet (see TS 38.214 [19],
clause 5.2)

TABLE 38
The CSI-AperiodicTriggerStateList IE is used to configure the UE with a list of
aperiodic trigger states. Each codepoint of the DCI field “CSI request” is associated with
one trigger state. Upon reception of the value associated with a trigger state, the UE will
perform measurement of CSI-RS (reference signals) and aperiodic reporting on L1
according to all entries in the associatedReportConfigInfoList for that trigger state.
CSI-AperiodicTriggerStateList information element

```
  -- ASN1START
  -- TAG-CSI-APERIODICTRIGGERSTATELIST-START
```

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-
AssociatedReportConfigInfo,
    ...
  }
```

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER |

(1..maxNrofNZP-CSI-RS-ResourceSetsPerConfig),

| | |
|---|---|
| qcl-info | SEQUENCE |

(SIZE(1..maxNrofAP-CSI-RS-ResourcesPerSet)) OF TCI-StateId OPTIONAL -- Cond
Aperiodic
},

| | |
|---|---|
| csi-SSB-ResourceSet | INTEGER (1..maxNrofCSI- |

SSB-ResourceSetsPerConfig)
},

| | |
|---|---|
| csi-IM-ResourcesForInterference | INTEGER(1..maxNrofCSI-IM- |

```
ResourceSetsPerConfig) OPTIONAL, -- Cond CSI-IM-ForInterference
    nzp-CSI-RS-ResourcesForInterference INTEGER (1..maxNrofNZP-CSI-RS-
ResourceSetsPerConfig) OPTIONAL, -- Cond NZP-CSI-RS-ForInterference
    ...
  }
  -- TAG-CSI-APERIODICTRIGGERSTATELIST-STOP
  -- ASN1STOP
```

CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId above (1
corresponds to the first entry, 2 to the second entry, and so on). The indicated CSI-IM-
ResourceSet should have exactly the same number of resources like the NZP-CSI-RS-
ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by reportConfigId
above (1 corresponds to the first entry, 2 to the second entry, and so on).
nzp-CSI-RS-ResourcesForInterference
NZP-CSI-RS-ResourceSet for interference measurement. Entry number in nzp-
CSI-RS-ResourceSetList in the CSI-ResourceConfig indicated by nzp-CSI-RS-
ResourcesForInterference in the CSI-ReportConfig indicated by reportConfigId above (1
corresponds to the first entry, 2 to the second entry, and so on).
qcl-info
List of references to TCI-States for providing the QCL source and QCL type for
each NZP-CSI-RS-Resource listed in nzp-CSI-RS-Resources of the NZP-CSI-RS-
ResourceSet indicated by nzp-CSI-RS-ResourcesforChannel. Each TCI-StateId refers to
the TCI-State which has this value for tci-StateId and is defined in tci-
StatesToAddModList in the PDSCH-Config included in the BWP-Downlink corresponding
to the serving cell and to the DL BWP to which the resourcesForChannelMeasurement
(in the CSI-ReportConfig indicated by reportConfigId above) belong to. First entry in qcl-
info-forChannel corresponds to first entry in nzp-CSI-RS-Resources of that NZP-CSI-RS-
ResourceSet, second entry in qcl-info-forChannel corresponds to second entry in nzp-CSI-
RS-Resources, and so on (see TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-
RS-ResourceSetList in the CSI-ResourceConfig indicated by
resourcesForChannelMeasurement in the CSI-ReportConfig indicated by reportConfigId
above (1 corresponds to the first entry, 2 to the second entry, and so on).

| Conditional | |
|---|---|
| Presence | Explanation |
| Aperiodic | The field is mandatory present if the NZP-CSI-RS- |
| | Resources in the associated resourceSet have the |
| | resourceType aperiodic. The field is absent otherwise. |
| CSI-IM- | This field is optional need M if the CSI- |
| ForInterference | ReportConfig identified by reportConfigId is configured |
| | with csi-IM-ResourcesForInterference; otherwise it is |
| | absent. |
| NZP-CSI-RS- | This field is optional need M if the CSI- |
| ForInterference | ReportConfig identified by reportConfigId is configured |
| | with nzp-CSI-RS-ResourcesForInterference; otherwise it is |
| | absent. |

TABLE 39
The CSI-SemiPersistentOnPUSCH-TriggerStateList IE is used to configure the UE
with list of trigger states for semi-persistent reporting of channel state information on L1.
See also TS 38.214 [19], clause 5.2.
CSI-SemiPersistentOnPUSCH-TriggerStateList information element

```
  -- ASN1START
  -- TAG-CSI-SEMIPERSISTENTONPUSCHTRIGGERSTATELIST-START
  CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-
TriggerState
```

| | |
|---|---|
| CSI-SemiPersistentOnPUSCH-TriggerState ::= | SEQUENCE { |
| associatedReportConfigInfo | CSI-ReportConfigId, |

```
    ...
  }
  -- TAG-CSI-SEMIPERSISTENTONPUSCHTRIGGERSTATELIST-STOP
  -- ASN1STOP
```

With respect to the aforementioned CSI report settings (CSI-ReportConfig), each report setting CSI-ReportConfig may be associated with one DL BWP identified by a higher-layer parameter BWP identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. For the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of a UL BWP configured for CSI report transmission. For the aperiodic CSI report method, a PUSCH resource in which CSI is to be transmitted may be scheduled for the UE by the base station via L1 signaling (e.g., aforementioned DCI format 0_1).

With respect to the aforementioned CSI resource settings (CSI-ResourceConfig), each CSI resource setting CSI-ReportConfig may include S (≥1) CSI resource sets (e.g., given via a higher-layer parameter of csi-RS-ResourceSetList). A CSI resource set list may include a NZP CSI-RS resource set and an SS/PBCH block set or may include a CSI-interference measurement (CSI-IM) resource set. Each CSI resource setting may be positioned in a DL BWP identified by higher-layer parameter bwp-id and may be connected to CSI report setting in the same DL BWP. A time domain step of a CSI-RS resource in CSI resource setting may be configured to be one of “aperiodic”, “periodic”, or “semi-persistent” from higher-layer the parameter of resourceType. With respect to the periodic or semi-persistent CSI resource setting, the number of CSI-RS resource sets may be limited to S (S=1), and the configured periodicity and slot offset may be given based on numerology of the DL BWP identified by bwp-id. One or more CSI resource settings for channel or interference measurement may be configured for the UE by the base station via higher-layer signaling, and may include, for example, the following CSI resources.
CSI-IM resource for interference measurement
NZP CSI-RS resource for interference measurement
NZP CSI-RS resource for channel measurement

With respect to CSI-RS resource sets associated with a resource setting in which the higher-layer parameter of resourceType is configured to be “aperiodic”, “periodic”, or “semi-persistent”, a trigger state of CSI report setting having report Type configured to be “aperiodic”, and a resource setting for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC CE. As described above, CSI resource setting may also be configured to be aperiodic, periodic, or semi-persistent. A combination of CSI reporting setting and CSI resource setting may be supported based on Table 40 below.

TABLE 40

| | Periodic | | |
|---|---|---|---|
| CSI-RS | CSI | Semi-Persistent | Aperiodic CSI |
| Configuration | Reporting | CSI Reporting | Reporting |
| Periodic | No dynamic | For reporting on | Triggered by DCI; |
| CSI-RS | triggering/ | PUCCH, the UE | additionally, |
| | activation | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Semi-Persistent | Not | For reporting on | Triggered by DCI; |
| CSI-RS | Supported | PUCCH, the UE | additionally, |
| | | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Aperiodic | Not | Not Supported | Triggered by DCI; |
| CSI-RS | Supported | | additionally, |
| | | | activation command |
| | | | [10, TS 38.321] |
| | | | possible as defined |
| | | | in Subclause |
| | | | 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.

When all bits in the CSI request field are 0, this may indicate that CSI reporting is not requested.

If the number M of configured CSI trigger states in CSI-AperiodicTriggerStateLite is greater than 2NTs−1, M CSI trigger states may be mapped to 2NTs−1 trigger states according to a predefined mapping relation, and one trigger state among the 2NTs−1 trigger states may be indicated by the CSI request field.

If the number M of configured CSI trigger states in CSI-AperiodicTriggerStateLite is less than or equal to 2NTs−1, one of the M CSI trigger states may be indicated by the CSI request field.

Table 41 below shows a relationship between a CSI request indicator and a CSI trigger state that may be indicated by a corresponding indicator.

TABLE 41

| CSI | | | |
|---|---|---|---|
| request | | CSI- | CSI- |
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to a UL data indicator (UL-SCH indicator) in DCI format 0_1 indicates “1”, the UE may multiplex UL data (UL-SCH) and the acquired CSI on the PUSCH resource scheduled by DCI format 0_1 so as to transmit the same. If one bit corresponding to the UL data indicator (UL-SCH indicator) in DCI format 0_1 indicates “0”, the UE may map only CSI, without UL data (UL-SCH), to the PUSCH resource scheduled by DCI format 0_1 to transmit the same.

The aperiodic CSI report may include at least one of or both CSI part 1 and CSI part 2, and when the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to REs within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as shown in Table 42 below.

```
TABLE 42
  For CSI part 1 transmission on PUSCH not using repetition type B with UL-SCH, the number of coded modulation symbols per layer
for CSI part 1 transmission, denoted as Q′_{CSI-part1}, is determined as follows:
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{SC}^{UCI} ( l )}{{\sum }_{r = 0}^{{C}_{UL - {SCH}^{- 1} {K}_{r}}}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} \}$
  . . .
  For CSI part 1 transmission on an actual repetition of a PUSCH with repetition Type B with UL-SCH, the number of coded modulation
symbols per layer for CSI part 1 transmission, denoted as Q′_{CSI-part1}, is determined as follows:
  ${Q}_{CSI - 1}^{′} = min \{ ⌈ \frac{\begin{matrix}( {O}_{CSI - 1} + {L}_{CSI - 1} ) \cdot {β}_{offset}^{PUSCH} \cdot \\ {\sum }_{l = 0}^{{N}_{symb , nominal}^{PUSCH} - 1} {M}_{sc , nominal}^{UCI} ( l )\end{matrix}}{{\sum }_{r = 0}^{{C}_{UL - {SCH}^{- 1} {K}_{r}}}} ⌉ , ⌈ α \cdot {{\sum }_{l = 0}}^{{N}_{symb , {nominal}^{- 1}}^{PUSCH}} {M}_{sc , nominal}^{UCI} ( l ) ⌉ - {Q}_{ACK / CG - UCI}^{′} , {{\sum }_{l = 0}}^{{N}_{symb , {actual}^{- 1}}^{PUSCH}} {M}_{sc , actual}^{UCI} ( l ) - {Q}_{ACK / CG - UCI}^{′} \}$
  . . .
  For CSI part 1 transmission on PUSCH without UL-SCH, the number of coded modulation symbols per layer for CSI part 1 transmission,
denoted as Q′_{CSI-part1}, is determined as follows:
  if there is CSI part 2 to be transmitted on the PUSCH,
    ${Q}_{C S I - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
  else
    ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
  end if
  . . .
  For CSI part 2 transmission on PUSCH not using repetition type B with UL-SCH, the number of coded modulation symbols per
layer for CSI part 2 transmission, denoted as QCSI-part2, is determined as follows:
    ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{s y mb , {all}^{- 1}}^{PUSCH}} {M}_{sc}^{UCI} ( l ) ⌉ - {Q}_{ACK / CG - UCI}^{′} - {Q}_{C S I - 1}^{′} \}$
  For CSI part 2 transmission on an actual repetition of a PUSCH with repetition Type B with UL-SCH, the number of coded modulation
symbols per layer for CSI part 2 transmission, denoted as Q′_{CSI-part2}, is determined as follows:
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {nominal}^{- 1}}^{PUSCH}} {M}_{sc , nominal}^{UCI} ( l )}{{\sum }_{r = 0}^{{C}_{UL - {SCH}^{- 1}}} {K}_{r}} ⌉ ,$
  $⌈ α \cdot {{\sum }_{l = 0}}^{{N}_{symb , {nominal}^{- 1}}^{PUSCH}} {M}_{sc , nominal}^{UCI} ( l ) ⌉ - {Q}_{ACK / CG - UCI}^{′} - {Q}_{C S I - 1}^{′} , {{\sum }_{l = 0}}^{{N}_{s y mb , {actual}^{- 1}}^{PUSCH}} {M}_{sc , actual}^{UCI} ( l ) - {Q}_{ACK / CG - UCI}^{′} - {Q}_{C S I - 1}^{′} \}$
  For CSI part 2 transmission on PUSCH without UL-SCH, the number of coded modulation symbols per layer for CSI part 2
transmission, denoted as Q′_{CSI-part2}, is determined as follows:
    ${Q}_{C S I - 2}^{′} = {\sum }_{l = 0}^{{N}_{symb , all}^{PUSCH} - 1} {M}_{s c}^{UCI} ( l ) - {Q}_{ACK}^{′} - {Q}_{CSI - 1}^{′}$
```

Specifically, for repeated PUSCH transmission schemes A and B, the UE may multiplex the aperiodic CSI report only on a first repeated transmission among repeated PUSCH transmissions, so as to transmit the same. Information on the multiplexed aperiodic CSI report may be encoded by a polar code scheme, and in this case, to be multiplexed on multiple PUSCH repetitions, each PUSCH repetition may need to have the same frequency and time resource allocation. In particular, for PUSCH repetition type B, each actual repetition may have a different OFDM symbol length, so that the aperiodic CSI report may be multiplexed only in the first PUSCH repetition so as to be transmitted.

In addition, for repeated PUSCH transmission scheme B, when the UE receives DCI for activation of semi-persistent CSI reporting or scheduling of aperiodic CSI reporting without scheduling for a transport block, the UE may assume that a value of nominal repetition is 1 even if the number of repeated PUSCH transmissions, which is configured via higher-layer signaling, is greater than 1. In addition, when the aperiodic or semi-persistent CSI reporting is scheduled or activated without scheduling for a transport block, based on repeated PUSCH transmission scheme B, the UE may expect that a first nominal repetition is identical to a first actual repetition. With respect to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be disregarded (i.e., ignored).

### UE Capability Report

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state to request a capability report. The message may include a UE capability request as to each radio access technology (RAT) type of the base station. The RAT type-specific request may include supported frequency band combination information and the like. In addition, in the UE capability enquiry message, UE capability as to multiple RAT types may be requested through one RRC message container transmitted by the base station, or the base station may transfer a UE capability enquiry message including multiple UE capability requests as to respective RAT types. That is, a capability enquiry may be repeated multiple times in one message, and the UE may configure a UE capability information message corresponding thereto and report the same multiple times. In next-generation mobile communication systems, a UE capability request may be made regarding multi-radio access technology (RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station, the UE may configure UE capability according to band information and RAT type requested by the base station. The method in which the UE configures UE capability in an NR system is summarized below.

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, that is, LTE bands may also be applied. BCs remaining after the above step may constitute the final “candidate BC list”.

4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). The UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

### CA/DC

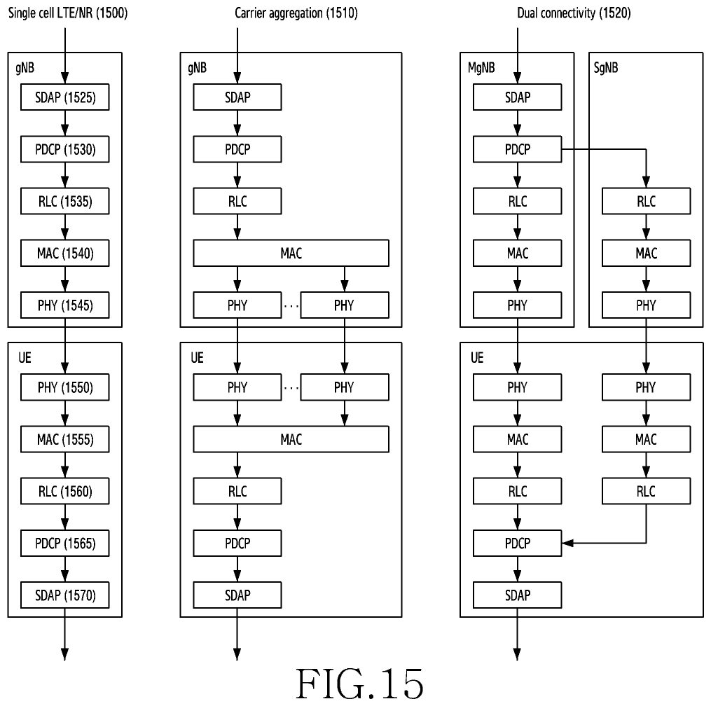

FIG. 15 illustrates radio protocol structures of a base station and a UE in single cell 1500, carrier aggregation 1510, and dual connectivity 1520 situations according to an embodiment.

Referring to FIG. 15, the radio protocol of a next-generation mobile communication system includes an NR service data adaptation protocol (SDAP) 1525 or 1570, an NR packet data convergence protocol (PDCP) 1530 or 1565, an NR radio link control (RLC) 1535 or 1560, and an NR medium access controls (MAC) 1540 or 1555, on each of UE and NR base station sides.

The main functions of the NR SDAP 1525 or 1570 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

As to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) QOS reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the UL and DL. The SDAP header may include QoS flow ID information indicating the QoS. The QoS information may be used as data processing priority, scheduling information, etc. for smoothly supporting services.

The main functions of the NR PDCP 1530 or 1565 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUS
Ciphering and deciphering
Timer-based SDU discard in UL

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 1535 or 1560 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. The in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1540 or 1555 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1545 or 1550 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, when the base station transmits data to the UE, based on a single carrier (or cell), the base station and the UE may use a protocol structure having a single structure as to each layer, such as 1500. On the other hand, when the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1510. As another example, when the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 1520.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, embodiments of the disclosure will be described in detail in conjunction with the accompanying drawings. The contents of the disclosure may be applied to FDD and TDD systems. As used herein, upper signaling (or upper layer signaling) is a method for transferring signals from a base station to a UE by using a DL data channel of a physical layer, or from the UE to the base station by using a UL data channel of the physical layer, and may also be referred to as “RRC signaling”, “PDCP signaling”, or “MAC CE”.

Hereinafter, the UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to when the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### NC-JT

Non-coherent joint transmission (NC-JT) may be used for the UE to receive PDSCHs from multiple TRPs.

Unlike the conventional system, the 5G wireless communication system may support not only a service requiring a high transmission rate, but also a service having a very short transmission delay and a service requiring a high connection density. In a wireless communication network including multiple cells, transmission and reception points (TRPs), or beams, cooperative communication (coordinated transmission) between the respective cells, TRPs, or/and beams may satisfy various service requirements by enhancing the strength of a signal received by a UE or efficiently performing interference control between the respective cells, TRPs, or/and beams.

Joint transmission (JT) is a representative transmission scheme for the aforementioned cooperative communication, and is a scheme for increasing the strength or throughput of a signal received by a UE, by transmitting the signal to one UE via multiple different cells, TRPs, and/or beams. In this case, channels between the UE and the respective cells, TRPs, and/or beams may have significantly different characteristics, and in particular, NC-JT supporting non-coherent precoding between the respective cells, TRPs, and/or beams may require individual precoding, MCS, resource allocation, TCI indication, etc. according to a channel characteristic for each link between the UE and the respective cells, TRPs, and/or beams.

The aforementioned NC-JT transmission may be applied to at least one channel among a PDSCH, a PDCCH, a PUSCH), and PUCCH. During PDSCH transmission, transmission information, such as precoding, MCS, resource allocation, and TCI, is indicated via DL DCI, and for NC-JT transmission, the transmission information should be independently indicated for each cell, TRP, and/or beam. This becomes a major factor in increasing a payload required for DL DCI transmission, which may adversely affect reception performance of a PDCCH which transmits DCI. Therefore, to support JT of a PDSCH, it is necessary to carefully design tradeoff between the amount of DCI information and control information reception performance.

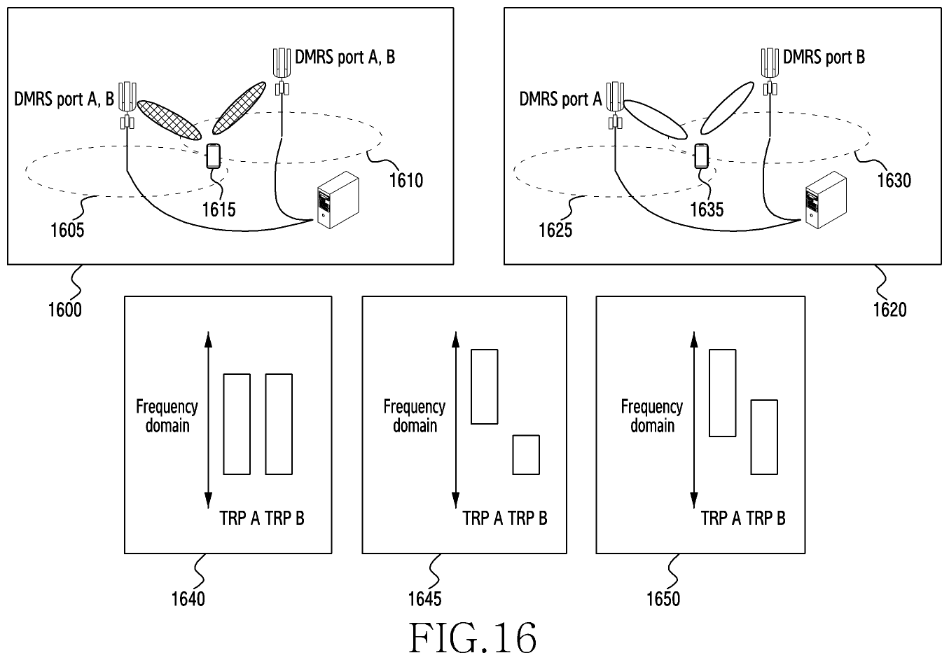

FIG. 16 illustrates an antenna port configuration and resource allocation for PDSCH transmission using cooperative communication in the wireless communication system according to an embodiment.

Referring to FIG. 16, an example for PDSCH transmission is described for each joint transmission (JT) scheme, and examples for radio resource allocation for each TRP are illustrated.

In addition, an example 1600 for coherent joint transmission (C-JT) supporting coherent precoding between respective cells, TRPs, or/and beams is illustrated.

For C-JT, TRP A 1605 and TRP B 1610 transmit a single piece of data (PDSCH) to a UE 1615, and joint precoding may be performed in multiple TRPs. This may indicate that DMRSs are transmitted through identical DMRS ports for TRP A 1605 and TRP B 1610 to transmit the same PDSCH. For example, TRP A 1605 and TRP B 1610 may transmit DMRSs to the UE through DMRS port A and DMRS port B, respectively. In this case, the UE may receive one piece of DCI for reception of one PDSCH demodulated based on the DMRSs transmitted via DMRS port A and DMRS port B.

FIG. 16 shows an example 1620 of NC-JT supporting non-coherent precoding between respective cells, TRPs, and/or beams for PDSCH transmission.

For NC-JT, a PDSCH is transmitted to a UE 1635 for each cell, TRP, or/and beam, and individual precoding may be applied to each PDSCH. Each cell, TRP, and/or beam may transmit a different PDSCH or a different PDSCH layer to the UE, thereby improving a throughput compared to single-cell, TRP, and/or beam transmission. Each cell, TRP, and/or beam repeatedly transmits the same PDSCH to the UE, thereby improving reliability compared to single-cell, TRP, and/or beam transmission. For convenience of description, a cell, a TRP, and/or a beam may be collectively referred to as a TRP.

In this case, various radio resource allocations may be considered, such as a case 1640 where frequency and time resources used in multiple TRPs for PDSCH transmission are identical, a case 1645 where frequency and time resources used in multiple TRPs do not overlap, and a case 1650 where some of frequency and time resources used in multiple TRPs overlap.

For NC-JT support, DCI of various types, structures, and relations may be considered to assign multiple PDSCHs simultaneously to a single UE.

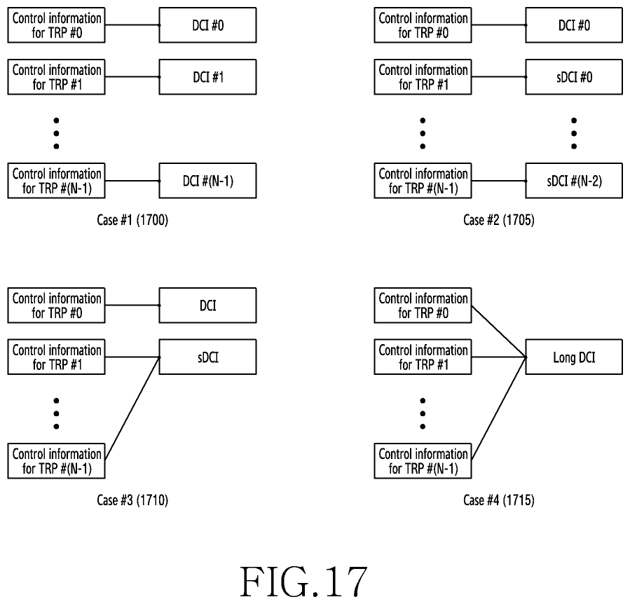

FIG. 17 illustrates configurations of DCI for NC-JT in which respective TRPs transmit different PDSCHs or different PDSCH layers to a UE in the wireless communication system according to an embodiment.

Referring to FIG. 17, case #1 1700 is an example in which, in when different N−1 PDSCHs are transmitted from N−1 additional TRPs (TRP #1 to TRP #N−1) in addition to a serving TRP (TRP #0) used during single PDSCH transmission, control information for PDSCHs transmitted in the additional N−1 TRPs is transmitted independently of control information for a PDSCH transmitted in the serving TRP. That is, the UE may acquire control information for PDSCHs transmitted from different TRPs (TRP #0 to TRP #N−1) via independent pieces of DCI (DCI #0 to DCI #N−1). Formats between the independent pieces of DCI may be the same or different from each other, and payloads between the DCI may also be the same or different from each other. In case #1, each PDSCH control or allocation freedom may be ensured, but if respective pieces of DCI are transmitted from different TRPs, a coverage difference per DCI may occur and thus reception performance may be deteriorated.

Case #2 1705 may be dependent on control information for a PDSCH, in which, in when N−1 different PDSCHs are transmitted from N−1 additional TRPs (TRP #1 to TRP #N−1) in addition to a serving TRP (TRP #0) used during single PDSCH transmission, DCI for PDSCHs of the respective additional N−1 TRPs is transmitted, and each piece of the DCI is transmitted from the serving TRP.

For example, DCI #0, which is control information for the PDSCH transmitted from the serving TRP (TRP #0), includes all information elements of DCI format 1_0, DCI format 1_1, and DCI format 1_2, but shortened DCI (hereinafter, sDCI) (sDCI #0 to sDCI #N−2), which is control information for the PDSCHs transmitted from the cooperative TRPs (TRP #1 to TRP #N−1), may include only some of the information elements of DCI format 1_0, DCI format 1_1, and DCI format 1_2. Accordingly, in sDCI for transmission of the control information for the PDSCHs transmitted from the cooperative TRPs, a payload is small compared to normal DCI (nDCI) for transmission of the control information related to the PDSCH transmitted from the serving TRP, so that reserved bits may be included in comparison with nDCI.

In case #2, each PDSCH control or allocation freedom may be restricted according to content of an information element included in sDCI, but since reception performance of sDCI is superior to that of nDCI, a probability that a coverage difference occurs per DCI may be decreased.

Case #3 1710 may be dependent on control information for a PDSCH, in which, in when N−1 different PDSCHs are transmitted from N−1 additional TRPs (TRP #1 to TRP #N−1) in addition to a serving TRP (TRP #0) used during single PDSCH transmission, one piece of DCI for PDSCHs of the N−1 additional TRPs is transmitted, and the DCI is transmitted from the serving TRP.

For example, for DCI #0 which is control information of a PDSCH transmitted from the serving TRP (TRP #0), all information elements of DCI format 1_0, DCI format 1_1, and DCI format 1_2 are included, and for control information of PDSCHs transmitted from cooperative TRPs (TRP #1 to TRP #N−1), it may be possible that only some of the information elements of DCI format 1_0, DCI format 1_1, and DCI format 1_2 are collected in one piece of “secondary” DCI (sDCI) to be transmitted. For example, the sDCI may include at least one piece of HARQ-related information, such as frequency domain resource assignment, time domain resource assignment, and MCS of cooperative TRPs. In addition, information that is not included in the sDCI, such as a BWP indicator or a carrier indicator, may be based on the DCI (DCI #0, normal DCI, or nDCI) of the serving TRP.

In case #3 1710, each PDSCH control or allocation freedom may be restricted according to content of the information element included in the sDCI, but sDCI reception performance may be adjustable, and complexity of DCI blind decoding of the UE may be reduced compared to case #1 1700 or case #2 1705.

In case #4 1715, when N−1 different PDSCHs are transmitted from N−1 additional TRPs (TRP #1 to TRP #N−1) in addition to a serving TRP (TRP #0) used during single PDSCH transmission, control information for PDSCHs transmitted from the N−1 additional TRPs is transmitted in the same DCI (long DCI) as that for the control information for the PDSCH transmitted from the serving TRP. That is, the UE may acquire the control information for the PDSCHs transmitted from different TRPs (TRP #0 to TRP #N−1) via a single piece of DCI. For case #4 1715, complexity of DCI blind decoding of the UE may not increase, but a PDSCH control or allocation freedom may be low, such that the number of cooperative TRPs is limited according to long DCI payload restrictions.

Herein, sDCI may refer to various auxiliary DCI, such as shortened DCI, secondary DCI, and normal DCI (aforementioned DCI format 1_0 or 1_1) including PDSCH control information transmitted in the coordinated TRPs, and if no particular restriction is specified, the descriptions may be similarly applicable to the various auxiliary DCI.

Case #1 1700, case #2 1705, and case #3 1710, in which one or more pieces of DCI are used for NC-JT support, may be classified as multiple-PDCCH-based NC-JT, and aforementioned case #4 1715, in which a single piece of DCI (PDCCH) is used for NC-JT support, may be classified as single-PDCCH-based NC-JT. In multiple-PDCCH-based PDSCH transmission, a CORESET in which DCI of the serving TRP (TRP #0) is scheduled and a CORESET in which DCI of the cooperative TRPs (TRP #1 to TRP #N−1) are scheduled may be distinguished. For example, to distinguish CORESETs, a method via a higher-layer indicator for each CORESET or a method via a beam configuration for each CORESET may be included. In the single-PDCCH-based NC-JT, a single piece of DCI is used for scheduling of a single PDSCH having multiple layers, instead of scheduling of multiple PDSCHs, and the aforementioned multiple layers may be transmitted from multiple TRPs. In this case, a connection relationship between a layer and a TRP for transmitting the layer may be indicated via a TCI indication for the layer.

Herein, “cooperative TRP” may be replaced with various terms, such as “cooperative panel” or “cooperative beam” when actually applied.

Herein, “when NC-JT is applied” may be interpreted in various manners depending on a situation, such as “when a UE receives one or more PDSCHs at the same time in one BWP”, “when a UE receives PDSCH based on two or more TCIs) at the same time in one BWP”, “when a PDSCH received by a UE is associated with one or more DMRS port groups”, etc., but one expression is used for convenience of description.

A radio protocol structure for NC-JT may be used in various manners herein according to a TRP deployment scenario. For example, if there is a small backhaul delay or no backhaul delay between cooperative TRPs, a method (CA-like method) using a structure based on MAC layer multiplexing is possible in a similar manner to section 1510 of FIG. 15. On the other hand, if a backhaul delay between cooperative TRPs is so large that the backhaul delay cannot be disregarded (e.g., when a time of 2 ms or longer is required for exchange of information, such as CSI, scheduling, and HARQ-ACK, between the cooperative TRPs), a method (DC-like method) of securing characteristics robust to a delay by using an independent structure for each TRP starting from the RLC layer is possible in a similar manner to section 1520 of FIG. 15.

The UE supporting C-JT/NC-JT may receive a C-JT/NC-JT-related parameter, setting value, or the like from a higher-layer configuration, and may set an RRC parameter of the UE, based on the parameter, the setting value, or the like. For the higher-layer configuration, the UE may use a UE capability parameter tci-StatePDSCH, which may define TCI states for PDSCH transmission. The number of the TCI states may be configured to be 4, 8, 16, 32, 64, and 128 in FRI and configured to be 64 and 128 in FR2, and among the configured numbers, up to 8 states that may be indicated by 3 bits of a TCI field in the DCI may be configured via a MAC CE message. The maximum value of 128 may refer to a value indicated by maxNumberConfiguredTCIstatesPerCC in the parameter of tci-StatePDSCH included in capability signaling of the UE. In this manner, a series of configuration procedures from the higher-layer configuration to the MAC CE configuration may be applied to a beamforming change command or a beamforming indication for at least one PDSCH in one TRP.

### Multi-DCI Based Multi-TRP

A DL control channel for NC-JT transmission may be configured based on multiple PDCCHs.

In the multiple-PDCCH-based NC-JT, when DCI for PDSCH scheduling of each TRP is transmitted, a CORERSET or a search space distinguished for each TRP may be provided. The CORESET or search space for each TRP may be configured as at least one of the following cases.

Higher-layer index configuration for each CORESET: CORESET configuration information configured via a higher layer may include an index value, and a TRP for PDCCH transmission in a corresponding CORESET may be distinguished by a configured index value for each CORESET. That is, in a set of CORESETs having the same higher-layer index value, it may be considered or determined that the same TRP transmits the PDCCH, or that the PDCCH for scheduling of the PDSCH of the same TRP is transmitted. The index for each CORESET may be named as CORESETPoolIndex, and for CORESETs for which the same CORESETPoolIndex value has been configured, it may be considered or determined that PDCCHs are transmitted from the same TRP. For a CORESET for which no CORESETPoolIndex value has been configured, it may be considered or determined that a default value has been configured for CORESETPoolIndex, and the default value may be 0.

Multiple-PDCCH-Config configuration: Multiple values of PDCCH-Config may be configured in one BWP, and each PDCCH-Config may include a PDCCH configuration for each TRP. That is, a list of CORESETs for each TRP and/or a list of search spaces for each TRP may be configured in one PDCCH-Config, and one or more CORESETs and one or more search spaces included in one PDCCH-Config may be considered or determined to correspond to a specific TRP.

CORESET beam/beam group configuration: A TRP corresponding to a corresponding CORESET may be distinguished via a beam or beam group configured for each CORESET. For example, if the same TCI state is configured for multiple CORESETs, it may be considered or determined that the CORESETs are transmitted via the same TRP, or that a PDCCH for scheduling of a PDSCH of the same TRP is transmitted in the corresponding CORESET.

Search space beam/beam group configuration: A beam or beam group may be configured for each search space, and a TRP for each search space may be distinguished based on the configured beam or beam group. For example, when the same beam/beam group or TCI state is configured for multiple search spaces, it may be considered or determined that the same TRP transmits a PDCCH in a corresponding search space or that a PDCCH for scheduling of a PDSCH of the same TRP is transmitted in the corresponding search space.

As described above, by distinguishing the CORESETs or search spaces according to TRPs, it may be possible to classify PDSCH and HARQ-ACK information for each TRP, and based on this, it may be possible to independently generate an HARQ-ACK codebook and independently use a PUCCH resource for each TRP.

The configuration may be independent for each cell or each BWP. For example, while two different CORESETPoolIndex values are configured for a PCell, a CORESETPoolIndex value may not be configured for a specific SCell. In this case, it may be considered or determined that NC-JT transmission has been configured for the PCell, whereas NC-JT transmission has not been configured for the SCell for which no CORESETPoolIndex value has been configured.

### Single-DCI-Based Multi-TRP

A DL beam for NC-JT transmission may be configured based on a single PDCCH.

In single-PDCCH-based NC-JT, PDSCHs transmitted by multiple TRPs may be scheduled via one piece of DCI. In this case, the number of TCI states may be used for a method of indicating the number of TRPs which transmit corresponding PDSCHs. That is, if the number of TCI states indicated in DCI for scheduling of a PDSCH is two, single-PDCCH-based NC-JT transmission may be considered, and if the number of TCI states is one, single-TRP transmission may be considered. The TCI states indicated by the DCI may correspond to one or two TCI states among TCI states activated via a MAC-CE. If the TCI states of the DCI correspond to two TCI states activated via the MAC-CE, a correspondence is established between a TCI codepoint indicated in the DCI and the TCI states activated via the MAC-CE, and there may be two TCI states activated via the MAC-CE which correspond to the TCI codepoint.

The configuration may be independent for each cell or each BWP. For example, a PCell may have up to two activated TCI states corresponding to one TCI codepoint, whereas a specific SCell may have up to one activated TCI state corresponding to one TCI codepoint. In this case, it may be considered or determined that NC-JT transmission has been configured for the PCell, whereas no NC-JT transmission has been configured for the SCell.

### PHR (Power Headroom Reporting)

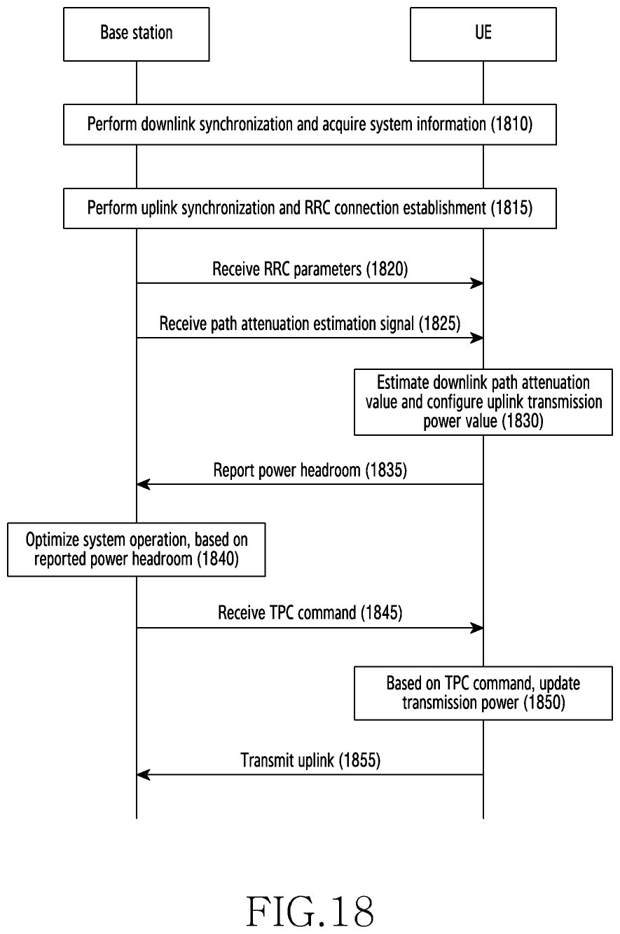

FIG. 18 illustrates a procedure in which a base station controls transmission power of a UE in a cellular system according to an embodiment.

Referring to FIG. 18, in step 1810, a UE in coverage of a base station may perform DL synchronization with the base station, and acquire SI. DL synchronization may be performed using a synchronization signal of a PSS/SSS received from the base station. UEs having performed DL synchronization may receive an MIB and SIB from the base station and acquire SI.

In step 1815, via a random-access procedure, the UE may perform UL synchronization with the base station and establish an RRC connection. In the random-access procedure, the UE may transmit a random-access preamble and message3 (msg3) to the base station via a UL. In this case, when the random-access preamble and message3 are transmitted, UL transmission power control may be performed. Specifically, the UE may receive parameters for the UL transmission power control from the base station via the acquired SI (e.g., the SIB) or may perform the UL transmission power control using a predetermined parameter. Alternatively, the UE may measure reference signal received power (RSRP) from a path attenuation estimation signal transmitted by the base station and may estimate a DL path attenuation value as shown in Equation (7) below. In addition, based on the estimated path attenuation value, the UE may configure a UL transmission power value for transmitting the random-access preamble and message3.

$$DL path attenuation = transmission power of a base station signal - RSRP measured by the UE \qquad ( 7 )$$

In Equation (7), the transmission power of the base station signal indicates transmission power of a DL path attenuation estimation signal transmitted by the base station. The DL path attenuation estimation signal transmitted by the base station may be a cell-specific reference signal (CRS) or a synchronization signal block (SSB). When the path attenuation estimation signal is a cell-specific reference signal (CRS), the transmission power of the base station signal may indicate transmission power of the CRS and may be transmitted to the UE via a referenceSignalPower parameter of the SI. When the path attenuation estimation signal is an SSB, the transmission power of the base station signal may indicate transmission power of an SSS and of a DMRS that is transmitted via a PBCH, and may be transmitted to the UE via an ss-PBCH-BlockPower parameter of the SI.

In step 1820, the UE may receive, from the base station, RRC parameters for the UL transmission power control via UE-specific RRC or common RRC. In this case, the received transmission power control parameters may be different from each other according to a UL channel type and a signal type. That is, transmission power control parameters to be applied to transmission of a PUCCH, a PUSCH, and a sounding reference signal (SRS) may be different from each other. In addition, as described above, a transmission power control parameter received by the UE from the base station via the SIB before RRC connection establishment or transmission power control parameters that the UE has used as predetermined values before the RRC connection establishment may be included in the RRC parameters transmitted from the base station after the RRC connection establishment. The UE may use an RRC parameter value, which is received from the base station after the RRC connection establishment, to control UL transmission power.

In step 1825, the UE may receive a path attenuation estimation signal from the base station. More specifically, after the RRC connection establishment of the UE, the base station may configure a CSI-RS as the path attenuation estimation signal for the UE. In this case, the base station may transmit information on transmission power of the CSI-RS to the UE via a powerControlOffsetSS parameter of UE-dedicated RRC information, which parameter may indicate a transmission power difference (offset) between the SSB and the CSI-RS.

In step 1830, the UE may estimate the DL path attenuation value and configure the UL transmission power value. More specifically, the UE may measure a DL RSRP by using the CSI-RS and may estimate the DL path attenuation value via expression 1 by using the information on transmission power of the CSI-RS received from the base station. In addition, based on the estimated DL path attenuation value, the UE may configure the UL transmission power value for PUCCH, PUSCH, and SRS transmission.

In step 1835, the UE may perform power headroom reporting (PHR) to the base station. A power headroom may indicate a difference between current transmission power of the UE and maximum output power of the UE.

In step 1840, the UE may optimize system operation, based on the reported power headroom. For example, if a power headroom value reported to the base station by a specific UE is a positive value, the base station may allocate more RBs to the UE, thereby increasing a system yield.

In step 1845, the UE may receive a TPC from the base station. If a power headroom value reported to the base station by a specific UE is a negative value, the base station may allocate fewer resources to the UE or may decrease transmission power of the UE via the TPC.

Accordingly, the system yield may be increased, or unnecessary power consumption of the UE may be decreased.

In step 1850, the UE may update transmission power, based on the TPC command. In this case, the TPC command may be transmitted to the UE via UE-specific DCI or group common DCI. Therefore, the base station may dynamically control transmission power of the UE via the TPC command.

In step 1855, the UE may perform UL transmission based on the updated transmission power.

### Pusch Power Control

PUSCH transmission power may be determined via Equation (8) below.

$${P}_{PUSCH} ( i , j , {q}_{d} , l ) = min \{ \begin{matrix}{P}_{CMAX , f , c} ( i ) , \\ \begin{matrix}{P}_{{0}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad ( 8 )$$

In Equation (8), P_{CMAX,f,c}(i) indicates maximum transmission power configured for the UE with respect to a carrier f of a serving cell c in a PUSCH transmission occasion i. P₀_{_{PUSCH}}_{,b,f,c}(j) is a configured reference transmission power configuration value according to an active UL BWP b of the carrier f of the serving cell c, and has different values according to various transmission types j. When PUSCH transmission corresponds to a message3 PUSCH for random access or the PUSCH is a configured grant PUSCH, or according to a scheduled PUSCH, various values may be provided. M_{RB,b,f,c}^{PUSCH}(i) may indicate a size of a frequency to which the PUSCH is allocated. α_{b,f,c}(j) may indicate a compensation rate degree value for a path loss of the UL BWP b of the carrier f of the serving cell c, may be configured by a higher signal, and may have different values according to j. PL_{b,f,c}(q_{d}) is a DL path loss estimation value of the UL BWP b of the carrier f of the serving cell c, and may use a value measured via a reference signal in an active DL BWP. The reference signal may be an SS/PBCH block or a CSI-RS. The DL path loss may be calculated as described above in Equation (7). In another embodiment of the disclosure, PL_{b,f,c}(q_{d}) is a DL path attenuation value and indicates path attenuation that the UE calculates using Equation (7). According to the higher-signal configuration, the UE may calculate the path attenuation based on a reference signal resource associated with the SS/PBCH block or CSI-RS. The reference signal resource may be selected to be one among various reference signal resource sets by a higher signal or an L1 signal, and the UE may calculate the path attenuation based on the reference signal resource. Δ_{TF,b,f,c}(i) is a value determined by a modulation and coding scheme (MCS) value of a PUSCH in the PUSCH transmission occasion i of the UL BWP b of the carrier f of the serving cell c. f_{b,f,c}(i, l) is a power adjustment adaptive value, and the UE may dynamically adjust a power value in response to a TPC command.

The TPC command is divided into an accumulated mode and an absolute mode, and one of the two modes may be determined by a higher signal. In the accumulated mode, a currently determined power adjustment adaptive value is accumulated to a value indicated by the TPC command, may be increased or decreased according to the TPC command, and may have a relation of f_{b,f,c}(i, l)=f_{b,f,c}(i−i₀, l)+Σδ_{PUSCH,b,f,c}. δ_{PUSCH,b,f,c} is the value indicated by the TPC command. The absolute mode may have a value determined by the TPC command regardless of the currently determined power adjustment adaptive value and may have a relation of f_{b,f,c}(i, l)=δ_{PUSCH,b,f,c}. Table 43 below shows values which may be indicated by the TPC command.

TABLE 43

| TPC | Accumulated | Absolute |
|---|---|---|
| Command | δ_{PUSCH, b, f, c} or | δ_{PUSCH, b, f, c} or |
| Field | δ_{SRS, b, f, c} [dB] | δ_{SRS, b, f, c} [dB] |
| 0 | −1 | −4 |
| 1 | 0 | −1 |
| 2 | 1 | 1 |
| 3 | 3 | 4 |

### Pucch Power Control

Equation (9) below is for determining PUCCH transmission power.

$$( 9 )$$

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + \\ {Δ}_{{F}_{PUCCH}} ( i ) + {Δ}_{TF , b , f , c} ( i ) + {f}_{b , f , c} ( i , l )\end{matrix}\end{matrix} \} [ dBm ]$$

In Equation (9), P₀_{_{PUCCH}}_{,b,f,c}(qᵤ) is a configured reference transmission power configuration value which may have different values according to various transmission types qᵤ, and may be changed by a higher-layer signal, such as RRC or MAC CE. When the value is changed via a MAC CE, with respect to a PDSCH on which the MAC CE has been received, and if a slot in which HARQ-ACK has been transmitted is k, the UE may determine that the value is to be applied from slot k+k_{offset}. k_{offset} has different values depending on respective subcarrier spacings, and may have, for example, 3 ms. M_{RB,b,f,c}^{PUCCH}(i) is a size of a frequency resource area to which a PUCCH is allocated. PL_{b,f,c}(q_{d}) is a path attenuation estimation value of the UE, which, as shown above in Equation (7), the UE may calculate based on a specific reference signal among various CSI-RSs or SS/PBCHs according to types and higher-signal configurations. The same q_{d} is applied to repeatedly transmitted PUCCHs. The same qᵤ may be applied to repeatedly transmitted PUCCHs.

### Initial Access Procedure

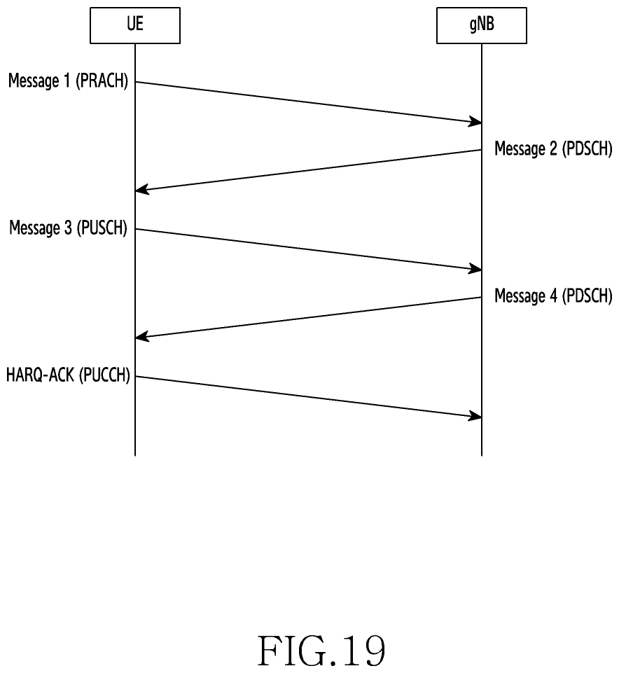

FIG. 19 illustrates a procedure in which a UE and a base station perform transmission and reception for initial connection in the wireless communication system according to an embodiment. Respective messages function as follows.

Msg1 (preamble transmission): A UE may select a random-access preamble from a set of predefined preambles. The random-access preamble may be divided into two categories: There may be a short preamble format and a long preamble format. The UE (hereinafter, terminal) may also select a random sequence number for the preamble. After selecting the preamble and sequence number, the UE may transmit the preamble on a PRACH.

Msg2 (random-access response): When Msg1 is received, a gNB (hereinafter, 5G base station or base station) may transmit a response referred to as Msg2 to the UE. Msg2 may include several pieces of important information, such as a time advance (TA) instruction for timing adjustment, a random-access preamble ID (RAPID) that matches the preamble transmitted by the UE, and an initial UL grant for the UE. The base station may assign a temporary identifier referred to as a random-access radio network temporary identifier (RA-RNTI) to the UE. The Msg2 information may be transferred via a PDSCH.

Msg3: The UE may transmit Msg3 on a PUSCH by using the initial UL grant provided in Msg2. Msg3 may be a PUSCH that may transfer a specific RRC message (e.g., RrcRequest) or may be pure PHY data.

Msg4 (contention resolution): After processing Msg3, the base station may transmit Msg4 to the UE. Msg4 may be MAC data for contention resolution. Since a contention resolution message includes identity of the UE, the base station may accurately identify the UE so as to enable identification that a contention has been resolved. During an Msg4 transmission operation, a network may provide the UE with a cell radio network temporary identifier (C-RNTI). Then, the UE may add information on whether Msg4 reception is successful (or HARQ-ACK feedback) to a PUCCH and transmit the PUCCH to the base station. The feedback may be an HARQ PUCCH for an Msg4 PDSCH.

The procedure above has been described as a procedure for initial access. However, after the initial access, when a beam failure report (BFR) is generated, or although there is data to be transmitted on a UL, if there is no scheduling request (SR) resource or there is no response from the base station after SR transmission, the UE may use the described procedure to search for an optimal beam again or to receive reallocation of a UL resource. In BFR, the UE may measure L1-RSRP via reference signal reception, and when a corresponding measured signal value falls to less than or equal to a specific threshold value, the UE may determine that a beam failure has occurred. Then, the UE may search for other candidate beams. If a certain number of beam failures or more occurs, a BFR to search for candidate beams is triggered, and the UE may transmit BFR request information to the base station via PRACH transmission. Then, the base station may transmit response information for the BFR request to the UE via Msg2transmission.

### Repeated PUCCH Transmission

The UE may be indicated, by the base station, to transmit a PUCCH via as many slots as N_{PUCCH}^{repeat} by using a PUCCH resource. In this case, if the PUCCH resource is indicated by a DCI format, and a higher signal of pucch-RepetitionNrofSlots is included, the number N_{PUCCH}^{repeat} may be provided by the higher signal of pucch-RepetitionNrofSlots. Otherwise, the number N_{PUCCH}^{repeat} may be provided by a higher signal of nrofSlots. If, for repetition of PUCCH transmission in a slot, the UE determines that the number of available symbols for the PUCCH transmission is less than a value provided by nrofSymbols for a corresponding PUCCH format, the UE may not perform repeated PUCCH transmission in the slot. An SS/PBCH block symbol may be of an SS/PBCH block having a candidate SS/PBCH block index corresponding to an SS/PBCH block index indicated to the UE by ssb-PositionsInBurst in SIB1 or ssb-PositionsInBurst of ServingCellConfigCommon. If the UE is not provided with dl-OrJointTCI-StateList, the SS/PBCH block symbol may be indicated to the UE by ssb-PositionsInBurst of SSB-MTCAdditionalPCI associated with a symbol set of a slot corresponding to an SS/PBCH block configured for L1 beam measurement/reporting, or a physical cell ID having an active TCI state for a PDCCH or PDSCH. When the UE repeats transmission per slot, start symbols and lengths of PUCCHs repeated per slot may be the same.

If the UE performs PUCCH transmission over N_{PUCCH}^{repeat}>1 first slots, the UE performs PUSCH transmission over multiple slots, a second number of slots, via repeated transmission type A or TB processing over multiple slots, the PUCCH transmission overlaps with the PUSCH transmission in one or more slots, and a time condition for multiplexing UCI on a PUSCH in the overlapping slots is satisfied, then the UE may perform PUCCH transmission and may not perform PUSCH transmission in the overlapping slots. In addition, if the UE performs PUCCH transmission over N_{PUCCH}^{repeat}>1 first slots, the UE performs PUSCH transmission over a second number of slots via repeated transmission type B, the PUCCH transmission overlaps with actual PUSCH repetition in one or more slots, and a time for multiplexing UCI on a PUSCH for the overlapping actual PUSCH repetition is satisfied, then the UE may perform PUCCH transmission and may not perform actual repeated PUSCH transmission in the overlapping slots.

The UE may not repeatedly multiplex different UCI types in PUCCH transmission via N_{PUCCH}^{repeat}>1 slots. When the UE transmits a first PUCCH over one or more slots and transmits at least a second PUCCH over one or more slots, and transmission of the first PUCCH and transmission of the second PUCCH overlap in multiple slots, and if UCI type priority is HARQ-ACK>SR>high priority CSI>low priority CSI in each slot among the multiple slots, the UE may determine, for the earliest first PUCCH, a longest duration subsequent to the earliest start symbol, and the second PUCCH may overlap the earliest first PUCCH. Then, the UE may perform operations as follows.

The UE may not expect the first PUCCH and the second PUCCH to include a UCI type with the same priority starting from one slot.

If one or more PUCCHs include a UCI type having the same highest priority in the first PUCCH and the second PUCCH, the UE may transmit the PUCCH having the highest priority in the earliest slot and may not transmit other PUCCHs. Otherwise,

The UE may transmit the PUCCH including the highest priority and may include no PUCCH having lower priority.

The UE may repeat the described procedure until there is no overlap with all PUCCHs having repetition in the slot.

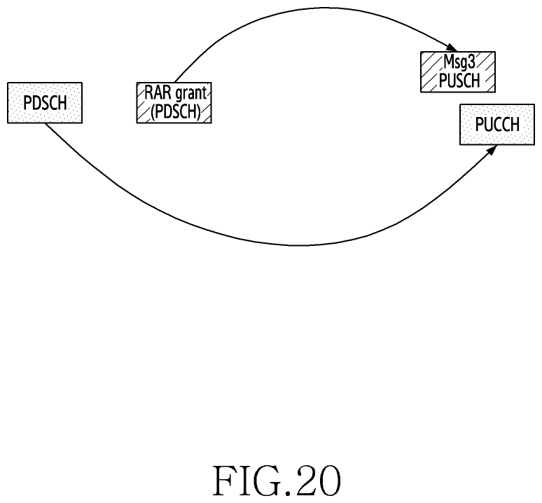

FIG. 20 illustrates when a Msg3 PUSCH and a PUCCH are scheduled in the wireless communication system according to an embodiment. An Msg3 PUSCH resource may be determined by information in an RAR grant, and a PUCCH may be determined by DCI for scheduling of a PDSCH. In this case, resource overlap of the Msg3 PUSCH and the PUCCH may occur. If a UE multiplexes UCI included in the PUCCH on the Msg3 PUSCH, a base station is unable to know which UE transmits the UCI, and therefore cannot know whether the UCI is multiplexed. Therefore, there may be a possibility that both the UCI and the PUSCH are lost and a random-access attempt fails. In this case, BFR and SR failure procedures are likely to occur since it is difficult for the base station to distinguish whether a UE transmitting the Msg3 PUSCH and a UE transmitting PUCCH are the same UE. In particular, if the UE transmitting the Msg3 PUSCH has previously performed contention-based random access (CBRA) on a PRACH, the base station may identify identification information of the UE after a random-access procedure is completed. It may be difficult for the base station to identify information of the UE transmitting the Msg3 PUSCH during the Msg3 PUSCH transmission operation. Therefore, if the Msg3 PUSCH and the PUCCH overlap in at least some symbols in terms of time resources, the UE may be able to drop the PUCCH and transmit only the Msg3 PUSCH. In other words, the UE may cure the above problems by transmitting only the Msg3 PUSCH without multiplexing the UCI of the PUCCH on the Msg3 PUSCH.

Descriptions are now provided for whether the UE transmits only the PUCCH, multiplexes UCI in the PUCCH on the PUSCH and transmits only the PUSCH, or transmits only the PUSCH without multiplexing the UCI in the PUCCH on the PUSCH, in consideration of whether PUCCH transmission is repeated transmission, whether PUSCH transmission includes Msg3 information, or whether PUSCH transmission repeated transmission. The described operations may be applied only to when a CBRA-based PRACH is transmitted.

### First Embodiment

In the first embodiment, descriptions are provided for an operation method of a UE in when an Msg3 PUSCH and a PUCCH overlap.

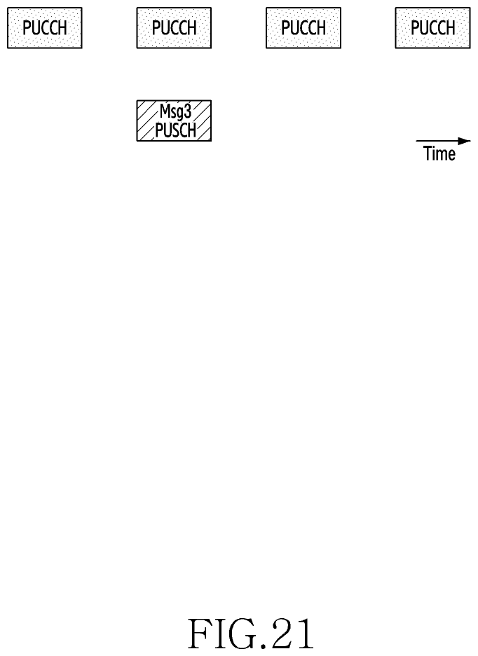

FIG. 21 illustrates when an Msg3 PUSCH and a PUCCH are scheduled in the wireless communication system according to an embodiment. Referring to FIG. 21, when a UE is performing repeated PUCCH transmission, second repeated PUCCH transmission overlaps an Msg3 PUSCH. A PUCCH may include HARQ-ACK, SR, or CSI information. The PUCCH may be a PUCCH resource periodically configured by a higher signal or a PUCCH resource scheduled in DCI. In this situation, the UE may drop the second repeated PUCCH transmission and transmit only the Msg3 PUSCH. The UCI of the PUCCH may not be multiplexed on the Msg3 PUSCH. Therefore, when the UE performs repeated PUCCH transmission, if at least one PUCCH overlaps another PUSCH, the UE may perform the following operations depending on whether the PUSCH is an Msg3 PUSCH. For reference, a method of determining whether the PUSCH is a Msg3 PUSCH may include that the UE determines a resource for scheduling of a corresponding PUSCH resource is an Msg2 PDSCH, determines as a Msg3 PUSCH, and determines all other PUSCHs as non-Msg3 PUSCHs.

Operation 1-1: For the PUSCH being the Msg3 PUSCH, the UE may drop the overlapping PUCCH and transmit only the Msg3 PUSCH. The UCI of the PUCCH may not be multiplexed on the Msg3 PUSCH.

Operation 1-2: For the PUSCH being a non-Msg3 PUSCH, it may be possible that the UE drops the overlapping PUSCH and transmits only the PUCCH.

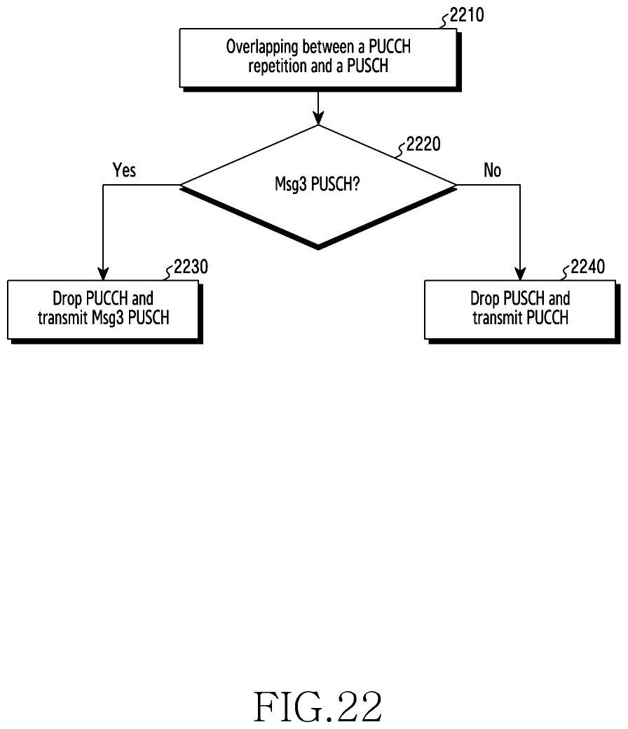

FIG. 22 illustrates a UL transmission signal and resource determination method of a UE in the wireless communication system according to an embodiment. Referring to FIG. 22, the procedure may be described as in Table 44 or Table 45 below. The described operations may be applied only to when a CBRA-based PRACH is transmitted.

```
TABLE 44
  - If a UE would transmit a PUCCH over a first number N_{PUCCH}^{repeat} > 1of slots and the
UE would transmit a PUSCH with repetition Type A or with TB processing over multiple
slots over a second number of slots, and the PUCCH transmission would overlap with the
PUSCH transmission in one or more slots, and the conditions in clause 9.2.5 for multiplexing
the UCI in the PUSCH are satisfied in the overlapping slots, the UE transmits the PUCCH
and does not transmit the PUSCH in the overlapping slots.
  - If a UE would transmit a PUCCH over a first number N_{PUCCH}^{repeat} > 1of slots and the
UE would transmit a Msg3 PUSCH over multiple slots over a second number of slots, and
the PUCCH transmission would overlap with the PUSCH transmission in one or more slots,
and the conditions in clause 9.2.5 for multiplexing the UCI in the PUSCH are satisfied in
the overlapping slots, the UE transmits the Msg3 PUSCH and does not transmit the PUCCH
in the overlapping slots.
```

```
TABLE 45
  - When a UE transmits multiple PUSCHs on respective serving cells in a slot with
reference to slots for PUCCH transmissions and the multiple PUSCHs overlap with a
PUCCH carrying UCI in the slot, the UE selects all the PUSCHs other than Msg3 PUSCH
that overlap with the PUCCH as the candidate PUSCHs for UCI multiplexing within the
slot.
  - If a UE would transmit a single PUSCH scheduled by a DCI format that includes a
DAI field on a serving cell in a slot with reference to slots for PUCCH transmissions without
any other PUSCH that would be transmitted on any serving cell in the slot and the UE does
not determine any PUCCH carrying HARQ-ACK information in the slot, or if the UE
indicates the corresponding capability mux-HARQ-ACK-withoutPUCCH-onPUSCH and
the UE transmits multiple PUSCHs on respective serving cells in a slot with reference to
slots for PUCCH transmissions and the UE does not determine any PUCCH carrying
HARQ-ACK information in the slot and at least one of the multiple PUSCHs is scheduled
by a DCI format that includes a DAI field, the UE selects the single PUSCH or all the
multiple PUSCHs in the slot as the candidate PUSCHs for HARQ-ACK multiplexing within
the slot except for any PUSCH among the multiple PUSCHs that is scheduled by a DCI
format that includes a DAI field that is equal to 4 in case the UE is configured with pdsch-
HARQ-ACK-Codebook = dynamic or with pdsch-HARQ-ACK-Codebook-r16, or is equal
to 0 in case the UE is configured with pdsch-HARQ-ACK-Codebook = semi-static. A Msg3
PUSCH is not considered as a candidate PUSCH for HARQ-ACK multiplexing.
  - If a Msg3 PUSCH overlaps with a PUCCH and the UCI is not multiplexed on any
other PUSCH, the UCI is dropped and the UE does not transmit the PUCCH. The UE
determines the PUSCH for UCI multiplexing by applying the following procedure on the
candidate PUSCHs as described in this clause:
  - When a UE determines overlapping for PUCCH and/or PUSCH transmissions of
the same priority index other than PUCCH transmissions with SL HARQ-ACK reports
before considering limitations for UE transmission due to cell DRX operation [11, TS
38.321] or as described in clauses 11.1, 11.1.1, 11.2A, 15 and 17.2 including repetitions if
any,
    first, the UE resolves the overlapping for PUCCHs with repetitions as
described in clause 9.2.6, if any
    second, the UE resolves the overlapping for PUCCHs without repetitions as
described in clauses 9.2.5
    third, the UE resolves the overlapping for PUSCHs except for Msg3 PUSCH
and PUCCHs with repetitions as described in clause 9.2.6
    fourth, the UE resolves the overlapping for PUSCHs and PUCCHs without
repetitions as is subsequently described in this clause.
```

For example, if a second PUCCH transmission resource among repeatedly transmitted PUCCH resources in FIG. 21 overlaps an Msg3 PUSCH resource at least in terms of time resources, the UE may also drop (i.e., not transmit) not only the second PUCCH transmission resource but also subsequent PUCCH transmission resources (e.g., a third PUCCH transmission resource and a fourth PUCCH transmission resource) which do not overlap. Alternatively, the UE may also drop a first PUCCH transmission resource. The described operation may be applied only when the purpose of transmitting the Msg3 PUSCH by the UE (e.g., the purpose of previous PRACH transmission) is BFR or other link recovery. If the purpose of transmitting the Msg3 PUSCH by the UE (e.g., the purpose of previous PRACH transmission) is a scheduling request, the UE may drop the overlapping Msg3 PUSCH or drop only the overlapping second PUCCH transmission resource as in FIG. 21. The described operation may be applicable only to when the UE transmits a CBRA-based PRACH. For another example, when the UE transmits the PRACH for BFR or other link recovery, the UE may not transmit a PUSCH and a PUCCH scheduled by DCI after the PRACH transmission, the DCI being transmitted and received before the PRACH transmission.

### Second Embodiment

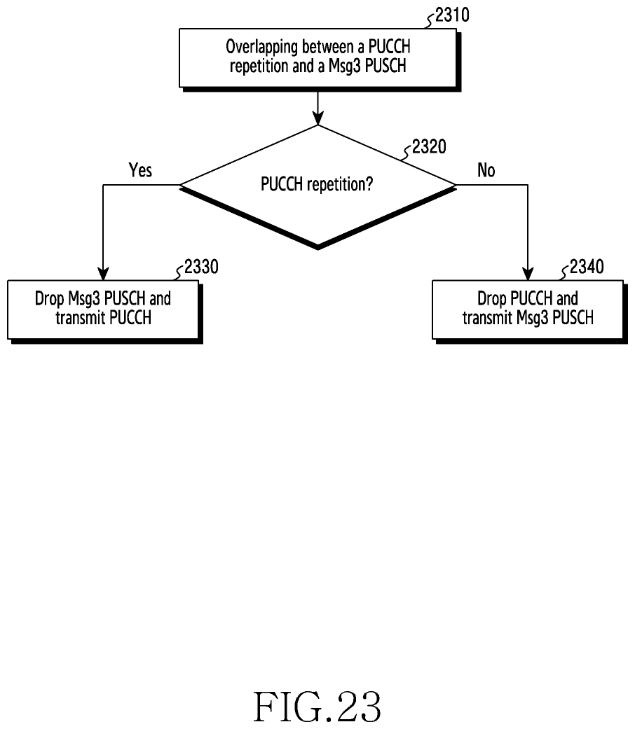

FIG. 23 illustrates a UL transmission signal and resource determination method of a UE in the wireless communication system according to an embodiment.

The first embodiment describes a UE operation according to whether a PUSCH is a Msg3 PUSCH when a specific PUCCH resource overlaps the PUSCH in terms of time resources at least in a repeated PUCCH transmission situation. Referring to FIG. 23, in step 2305, a UE operates according to whether a PUCCH transmission resource corresponds to a repeatedly transmitted PUCCH, when at least some resources for Msg3 PUSCH transmission and PUCCH transmission overlap in terms of time resources. For example, in step 2310, regardless of whether the PUCCH transmission resource corresponds to a repeatedly transmitted PUCCH, the UE may transmit, in step 2320, only a Msg3 PUSCH resource without multiplexing UCI of the PUCCH on the Msg3 PUSCH resource overlapping the PUCCH. In this case, the UE may not transmit the overlapping PUCCH and may drop the PUCCH. In step 2315, if the PUCCH transmission resource corresponds to a repeatedly transmitted PUCCH, the UE may transmit the PUCCH and may not transmit the Msg3 PUSCH. If the PUCCH transmission resource does not correspond to a repeatedly transmitted PUCCH, the UE may not transmit the PUCCH, may not multiplex the UCI of the PUCCH on the Msg3 PUSCH, and may transmit the Msg3 PUSCH. Whether the PUCCH transmission resource corresponds to a repeatedly transmitted PUCCH or not may be determined by a separate higher signal or layer 1 (L1) signal.

### Third Embodiment

A description is provided in a more general manner for a UE operation in when a PUSCH and a PUCCH have at least some overlapping resources in terms of time resources. The PUSCH and the PUCCH may include the following cases.

3-1: Overlapping of at least some resources in terms of time resources between a single transmission resource for PUSCH other than Msg3 and a single PUCCH transmission resource

3-2: Overlapping of at least some time resources between a single transmission resource for PUSCH other than Msg3 and a specific PUCCH transmission resource among repeated PUCCH transmission resources

3-3: Overlapping of at least some time resources between a specific PUSCH transmission resource among repeated transmission resources for PUSCH other than Msg3 and a single PUCCH transmission resource

3-4: Overlapping of at least some time resources between a specific PUSCH transmission resource among repeated transmission resources for PUSCH other than Msg3 and a specific PUCCH transmission resource among repeated PUCCH transmission resources

3-5: Overlapping of at least some time resources between a single Msg3 PUSCH transmission resource and a single PUCCH transmission resource

3-6: Overlapping of at least some time resources between a single Msg3 PUSCH transmission resource and a specific PUCCH transmission resource among repeated PUCCH transmission resources

3-7: Overlapping of at least some time resources between a specific Msg3 PUSCH transmission resource among repeated Msg3 PUSCH transmission resources and a single PUCCH transmission resource

3-8: Overlapping of at least some time resources between a specific Msg3 PUSCH transmission resource among repeated Msg3 PUSCH transmission resources and a specific PUCCH transmission resource among repeated PUCCH transmission resources

For the repeated Msg3 PUSCH transmission described in cases 3-7 and 3-8, when specific RACH resource information is provided in advance via a higher-signal configuration, and the UE transmits a PRACH via a specific RACH resource, a base station may determine that the UE has requested repeated Msg3 PUSCH transmission. The base station may provide the UE with information on the number of repeated Msg3 PUSCH transmissions by using two MSBs in a 5-bit MCS fields in a Msg2 PDSCH (RAR UL grant). The UE may perform repeated Msg3 PUSCH transmission via the information received from the base station. For the aforementioned cases, the UE may perform at least one of the following operations.

Operation 3-1: The UE may transmit a PUSCH (or Msg3 PUSCH), may not transmit a PUCCH, and may not multiplex UCI of the PUCCH on the PUSCH (or Msg3 PUSCH).

Operation 3-2: The UE may transmit the PUSCH (or Msg3 PUSCH), may not transmit the PUCCH, and may multiplex the UCI of the PUCCH on the PUSCH (or Msg3 PUSCH).

Operation 3-3: The UE may transmit the PUCCH and may not transmit the PUSCH (or Msg3 PUSCH).

The UE may apply, to the aforementioned cases, some of the same or different operations. For example, if 3-1 occurs, the UE may apply operation 3-2. For another example, if 3-5 occurs, the UE may apply operation 3-1. The aforementioned operations may be applied only to when the UE has transmitted a CBRA-based PRACH. Alternatively, the aforementioned operations may be applied only to when the purpose of transmitting the CBRA-based PRACH by the UE is BFR or link recovery.

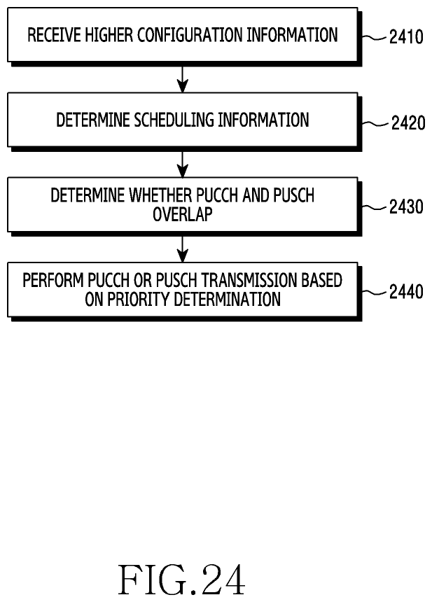

FIG. 24 illustrates a UL transmission signal and resource determination method of a UE in the wireless communication system according to an embodiment. Referring to FIG. 24, in step 2410, UE may receive configuration information from a base station in advance via a higher-layer signal. In step 2420, the UE may receive PUCCH or PUSCH (or Msg3 PUSCH) scheduling information via a separate higher-layer signal or L1 signal. In step 2430, the UE may determine whether at least some resources of scheduled resources overlap in terms of time resources. In step 2440, if the at least some resources overlap, the UE may perform the methods or operations described in the first to third embodiments described herein.

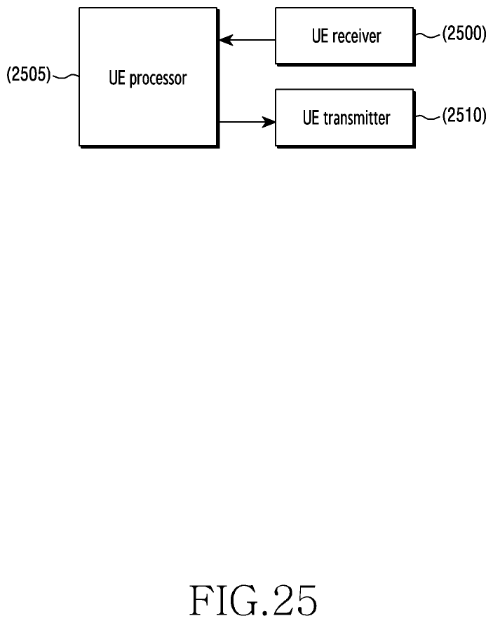

FIG. 25 illustrates a UE in a wireless communication system according to an embodiment.

Referring to FIG. 25, the UE may include a transceiver, which refers to a UE receiver 2500 and a UE transmitter 2510, a memory, and a UE processor 2505 (or UE controller or processor). The UE transceiver 2500 and 2510, the memory, and the UE processor 2505 may operate according to the above-described communication methods of the UE. Components of the UE are not limited to the above-described example. For example, the UE may include more or fewer components than the above-described components. The UE processor 2505, the UE transmitter 2510, the UE receiver 2500, and the memory may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for operations of the UE. The memory may store control information or data included in signals transmitted/received by the UE. The memory may include a storage medium such as a read only memory (ROM), a random access memory (RAM), a hard disk, a compact disc (CD)-ROM, or a digital versatile disc (DVD), or a combination of storage media. The memory may include multiple memories, and the memory may store instructions for performing the above-described communication methods.

The UE processor 2505 may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

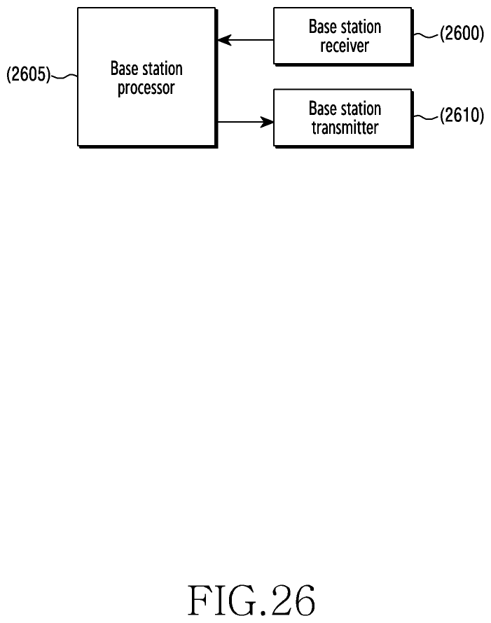

FIG. 26 illustrates a base station in a wireless communication system according to an embodiment.

Referring to FIG. 26, the base station may include a transceiver, which refers to a base station receiver 2600 and a base station transmitter 2610, a memory, and a base station processor 2605 (or base station controller or processor). The base station transceiver 2600 and 2610, the memory, and the base station processor 2605 may operate according to the above-described communication methods of the base station. However, components of the base station are not limited to the above-described example. For example, the base station may include more or fewer components than the above-described components. The base station receiver 2600, the base station transmitter 2610, the memory, and the base station processor 2605 may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for operations of the base station. The memory may store control information or data included in signals transmitted/received by the base station. The memory may include a storage medium such as a ROM, a RAM, a hard disk, a CD-ROM, or a DVD, or a combination of storage media. The memory may include multiple memories, and the memory may store instructions for performing the above-described communication methods.

The base station processor 2605 may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may be executed substantially concurrently or the blocks may sometimes be executed in the reverse order, depending upon the functionality involved.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
transmitting, to a base station, a random access preamble on a physical random access channel (PRACH); and
receiving, from the base station, a random access response (RAR) message including an RAR uplink (UL) grant,
wherein, in case that a physical uplink shared channel (PUSCH) scheduled by the RAR UL grant overlaps with a physical uplink control channel (PUCCH) carrying uplink control information (UCI), the UCI is not multiplexed on the PUSCH.

2. The method of claim 1, further comprising:
dropping a PUCCH transmission; and
transmitting, to the base station, an uplink signaling on the PUSCH.

3. The method of claim 1, further comprising:
transmitting, to the base station, the UCI on the PUCCH, in case that the PUCCH is included in PUCCH repetitions.

4. The method of claim 3, further comprising:
receiving, from the base station, information for indicating whether the PUCCH is included in the PUCCH repetitions.

5. The method of claim 2,
wherein resources for the PUCCH transmission overlap with at least one resource for a transmission of the PUSCH in a slot.

6. A method performed by a base station in a wireless communication system, the method comprising:
receiving, from a terminal, a random access preamble on a physical random access channel (PRACH); and
transmitting, to the terminal, a random access response (RAR) message including an RAR uplink (UL) grant,
wherein, in case that a physical uplink shared channel (PUSCH) scheduled by the RAR UL grant overlaps with a physical uplink control channel (PUCCH) carrying uplink control information (UCI), the UCI is not multiplexed on the PUSCH.

7. The method of claim 6, further comprising:
receiving, from the terminal, an uplink signaling on the PUSCH,
wherein a PUCCH reception is dropped.

8. The method of claim 6, further comprising:
receiving, from the terminal, the UCI on the PUCCH, in case that the PUCCH is included in PUCCH repetitions.

9. The method of claim 8, further comprising:
transmitting, to the terminal, information for indicating whether the PUCCH is included in the PUCCH repetitions.

10. The method of claim 7,
wherein resources for the PUCCH reception overlap with at least one resource for a reception of the PUSCH in a slot.

11. A terminal in a wireless communication system, the terminal comprising:
a transceiver; and
at least one processor coupled with the transceiver and configured to:
transmit, to a base station, a random access preamble on a physical random access channel (PRACH), and
receive, from the base station, a random access response (RAR) message including an RAR uplink (UL) grant,
wherein, in case that a physical uplink shared channel (PUSCH) scheduled by the RAR UL grant overlaps with a physical uplink control channel (PUCCH) carrying uplink control information (UCI), the UCI is not multiplexed on the PUSCH.

12. The terminal of claim 11, wherein the at least one processor is further configured to:
drop a PUCCH transmission, and
transmit, to the base station, an uplink signaling on the PUSCH.

13. The terminal of claim 11, wherein the at least one processor is further configured to:
transmit, to the base station, the UCI on the PUCCH, in case that the PUCCH is included in PUCCH repetitions.

14. The terminal of claim 13, wherein the at least one processor is further configured to:
receive, from the base station, information for indicating whether the PUCCH is included in the PUCCH repetitions.

15. The terminal of claim 12,
wherein resources for the PUCCH transmission overlap with at least one resource for a transmission of the PUSCH in a slot.

16. A base station in a wireless communication system, the base station comprising:
a transceiver; and
at least one processor coupled with the transceiver and configured to:
receive, from a terminal, a random access preamble on a physical random access channel (PRACH), and
transmit, to the terminal, a random access response (RAR) message including an RAR uplink (UL) grant,
wherein, in case that a physical uplink shared channel (PUSCH) scheduled by the RAR UL grant overlaps with a physical uplink control channel (PUCCH) carrying uplink control information (UCI), the UCI is not multiplexed on the PUSCH.

17. The base station of claim 16, wherein the at least one processor is further configured to:
receive, from the terminal, an uplink signaling on the PUSCH,
wherein a PUCCH reception is dropped.

18. The base station of claim 16, wherein the at least one processor is further configured to:
receive, from the terminal, the UCI on the PUCCH, in case that the PUCCH is included in PUCCH repetitions.

19. The base station of claim 18, wherein the at least one processor is further configured to:
transmit, to the terminal, information for indicating whether the PUCCH is included in the PUCCH repetitions.

20. The base station of claim 17,
wherein resources for the PUCCH reception overlap with at least one resource for a reception of the PUSCH in a slot.
